(19) United States
(12) Patent Application Publication
(10) Pub. No.: US 2026/0000971 A1
(43) Pub. Date: Jan. 1, 2026

(54) INFORMATION PROCESSING SYSTEM, NON-TRANSITORY STORAGE MEDIUM CONFIGURED TO STORE PROGRAM THEREIN, AND METHOD FOR PROCESSING TO BE EXECUTED BY COMPUTER OF INFORMATION PROCESSING APPARATUS

(71) Applicant: Nintendo Co., Ltd., Kyoto (JP)

(72) Inventors: Tsutomu ARAKI, Kyoto (JP); Shiro KATO, Kyoto (JP)

(21) Appl. No.: 19/222,569

(22) Filed: May 29, 2025

(30) Foreign Application Priority Data
Jun. 26, 2024 (JP) 2024-102967

(51) Int. Cl. A63F 13/22; G06F 3/0482; G06F 3/0484

(52) U.S. Cl. CPC A63F 13/22; G06F 3/0482; G06F 3/0484

(57) ABSTRACT

First key setting processing for a user to assign a desired function to each input portion of a first input portion set including two or more of a plurality of user-operable input portions provided to a controller, is executed, and second key setting processing for the user to assign a desired function to each input portion of a second input portion set including one or more input portions of the first input portion set, is executed.

### CROSS REFERENCE TO RELATED APPLICATION

This application claims priority to Japanese Patent Application No. 2024-102967 filed on June 26, 2024, the entire contents of which are incorporated herein by reference.

### FIELD

The present disclosure relates to information processing.

### BACKGROUND AND SUMMARY

There is known a technology that allows a user to change assignments of functions corresponding to operations on keys provided to a controller.

A method for setting assignments of functions to keys in a way more convenient for a user has been required.

Configuration examples are as follows.

One configuration example is an information processing system including: a controller including a plurality of user-operable input portions; at least one processor; and a non-transitory storage medium configured to store a program for causing a computer to execute a process when the program is executed by the at least one processor. The process includes first key setting processing for a user to assign a desired function to each input portion of a first input portion set including two or more of the plurality of input portions, and second key setting processing for the user to assign a desired function to each input portion of a second input portion set including one or more input portions of the first input portion set.

According to the above configuration example, the second key setting processing that allows a user to assign desired functions to the second input portion set including one or more input portions of the first input portion set is provided, whereby a user who desires to assign a function to the input portion of the second input portion set can be prevented from erroneously assigning a function to another input portion.

In another configuration example, the first key setting processing includes displaying a first screen for the user to assign a desired function to each of the input portions other than the second input portion set, in the first input portion set, displaying a second screen for the user to assign a desired function to each of the input portions of the second input portion set, and switching between display of the first screen and display of the second screen.

According to the above configuration example, it is possible to avoid confusion that can arise when all input portions are assigned with functions on one screen. In addition, since the second screen for assigning functions to the input portions of the second input portion set which can be assigned with functions also in the second key setting processing is provided, it is possible to provide menus that are easy for a user to understand.

In another configuration example, the second key setting processing may include displaying a third screen on which, of the first input portion set, present assignments of functions of the input portions of the second input portion set are indicated and present assignments of functions of the input portions other than the input portions of the second input portion set are not indicated.

According to the above configuration example, present assignments of functions are not indicated for the input portions that cannot be assigned with functions in the second key setting processing, and thus a user can be prevented from becoming confused.

In another configuration example, shift from a state during a sequence including the second key setting processing to the first key setting processing may not be allowed, and shift from a state during a sequence including the first key setting processing to the second key setting processing may not be allowed.

According to the above configuration example, a user can be prevented from becoming confused.

In another configuration example, the process may include storing assignments of functions for the input portions of the first input portion set as first storage data, and storing assignments of functions for the input portions of the second input portion set as second storage data, the first storage data may be data for, by being called, updating assignments of functions for the input portions of the first input portion set at a time of the calling, and the second storage data may be data for, by being called, updating assignments of functions for the input portions of the second input portion set at a time of the calling.

According to the above configuration example, since storage data of assignments of functions that can be called are managed separately from each other, convenience in storing assignments of functions and in calling the storage data can be improved.

In another configuration example, in a case where the second storage data is called and assignments of functions for the input portions of the second input portion set are updated, assignments of functions for the input portions other than the second input portion set may remain those at a time of the calling.

According to the above configuration example, in a case where setting of changing assignments of functions of keys other than certain keys has been made, the setting is maintained, and thus convenience can be improved.

In another configuration example, the process may include performing a first sequence which includes the first key setting processing and is started from a predetermined processing point, and performing a second sequence which includes the second key setting processing and is started from the predetermined processing point, the second sequence being independent of the first sequence. In the first sequence, assignments of functions for the input portions of the first input portion set may be allowed to be stored as the first storage data, and in the second sequence, assignments of functions for the input portions of the second input portion set may be allowed to be stored as the second storage data.

According to the above configuration example, convenience can be improved.

In another configuration example, the controller may include a first controller and a second controller of a type different from a type of the first controller. For each of the first controller and the second controller, the input portions assigned with no functions in initial states may be included in the second input portion set. The process may include not calling the first storage data stored for one of the first controller and the second controller, for another of the first controller and the second controller, and calling the second storage data stored for one of the first controller and the second controller, for another of the first controller and the second controller.

In another configuration example, the input portions of the second input portion set may be assigned with no functions, in initial states.

According to the exemplary embodiment, it is possible to provide an information processing system and the like that allow a user to perform setting of assignments of key functions more conveniently, for example.

### BRIEF DESCRIPTION OF THE DRAWINGS

FIG. 1 is an exterior view showing a non-limiting example of a main body apparatus 2, a left controller 3, a right controller 4, a first controller 5, and a second controller 6;

FIG. 2 is an exterior view showing a non-limiting example of the left controller 3 and the right controller 4;

FIG. 3 is an exterior view showing a non-limiting example of the second controller 6, and the first controller 5 with the left controller 3 and the right controller 4 attached thereto;

FIG. 4 is a block diagram showing a non-limiting example of the internal configuration of the main body apparatus 2;

FIG. 5 is a block diagram showing a non-limiting example of the internal configurations of the left controller 3, the right controller 4, the first controller 5, and the second controller 6;

FIG. 6 illustrates a non-limiting example of a setting top menu;

FIG. 7 illustrates a non-limiting example of a controller/setting item selection menu in a GL/GR key assignment sequence;

FIG. 8 illustrates a non-limiting example of a GL/GR key setting menu in the GL/GR key assignment sequence;

FIG. 9 illustrates a non-limiting example of a favorites saving menu in the GL/GR key assignment sequence;

FIG. 10 illustrates a non-limiting example of a favorites loading menu in the GL/GR key assignment sequence;

FIG. 11 illustrates a non-limiting example of a controller/setting item selection menu in an overall key assignment sequence;

FIG. 12 illustrates a non-limiting example of an overall key setting menu in the overall key assignment sequence;

FIG. 13 illustrates a non-limiting example of a favorites saving menu in the overall key assignment sequence;

FIG. 14 illustrates a non-limiting example of a favorites loading menu in the overall key assignment sequence;

FIG. 15 illustrates a non-limiting example of various data stored in a memory 61;

FIG. 16 illustrates a non-limiting example of controller identification data and key function assignment data;

FIG. 17 illustrates a non-limiting example of present key function assignment data;

FIG. 18 illustrates a non-limiting example of overall key favorites data;

FIG. 19 illustrates a non-limiting example of overall key favorites data;

FIG. 20 illustrates a non-limiting example of GL/GR key favorites data;

FIG. 21 illustrates a non-limiting example of GL/GR key favorites data;

FIG. 22 is a non-limiting example of a flowchart of a setting process;

FIG. 23 is a non-limiting example of a flowchart of the setting process;

FIG. 24 is a non-limiting example of a flowchart of the setting process; and

FIG. 25 is a non-limiting example of a flowchart of the setting process.

### DETAILED DESCRIPTION OF NON-LIMITING EXAMPLE EMBODIMENTS

Hereinafter, one exemplary embodiment will be described.

### [Hardware configuration of information processing system]

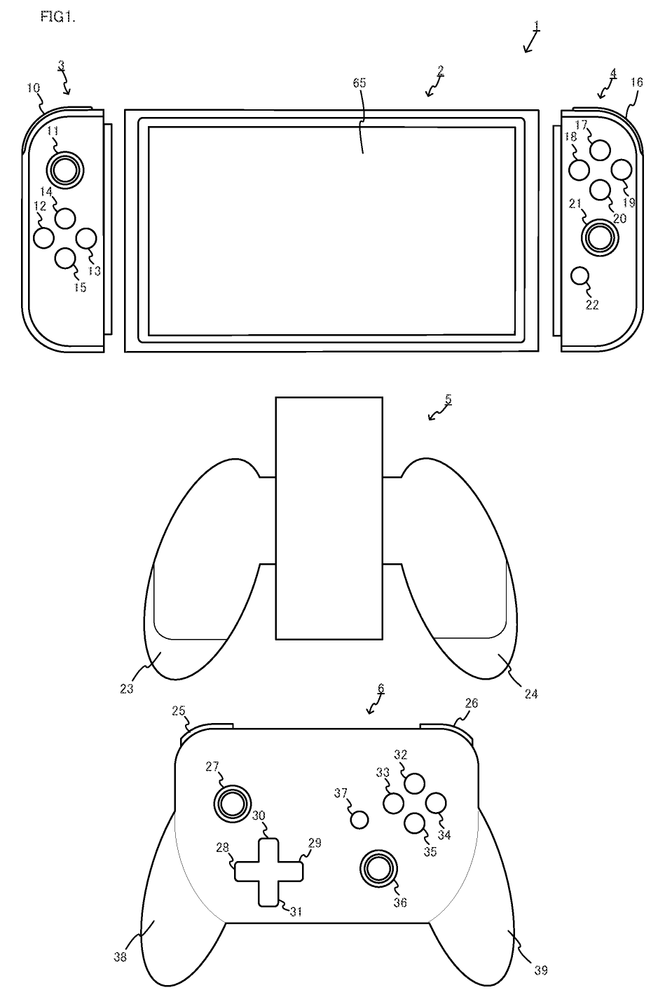

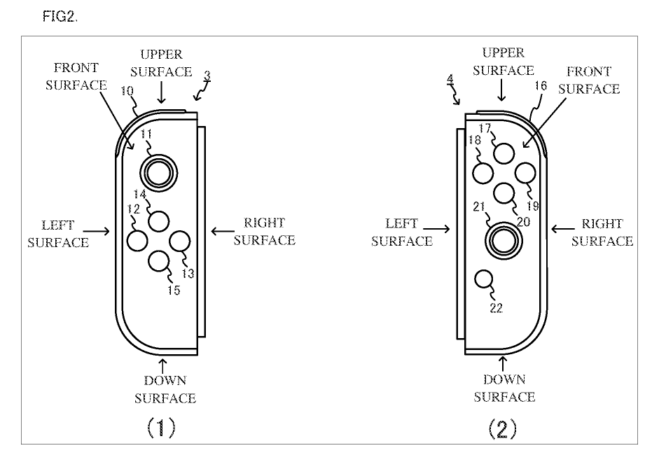

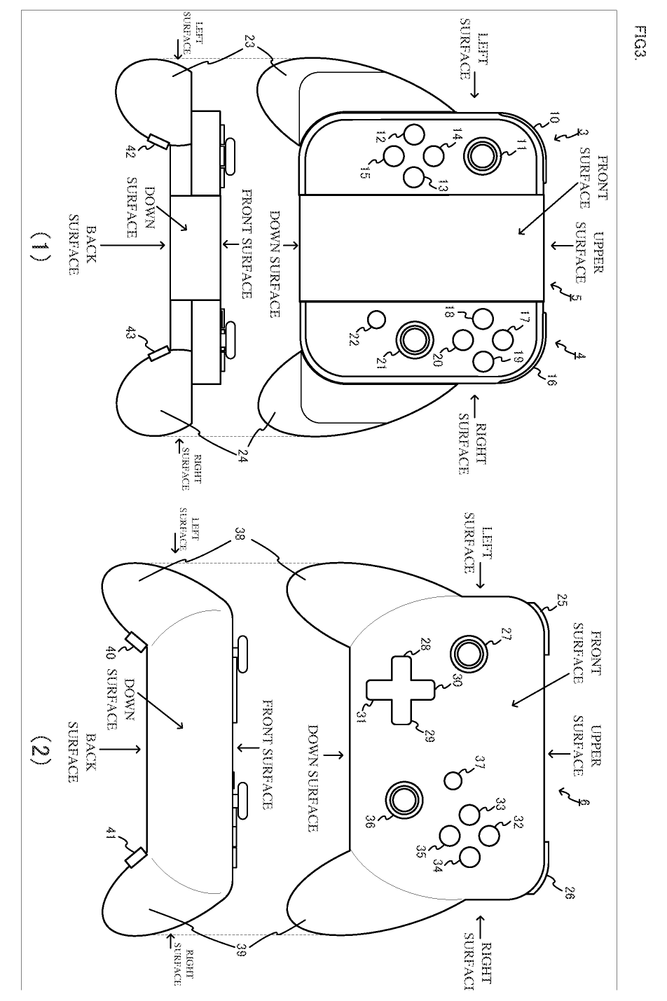

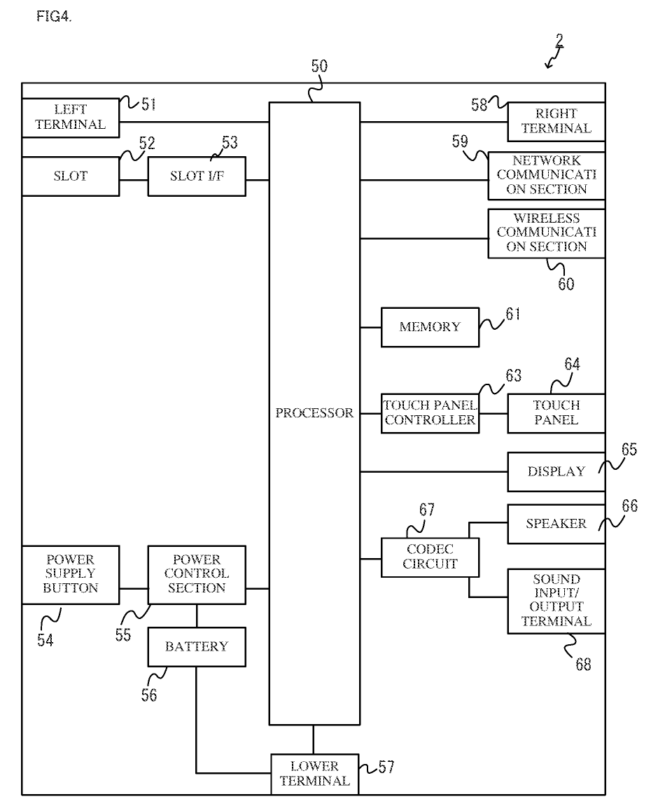

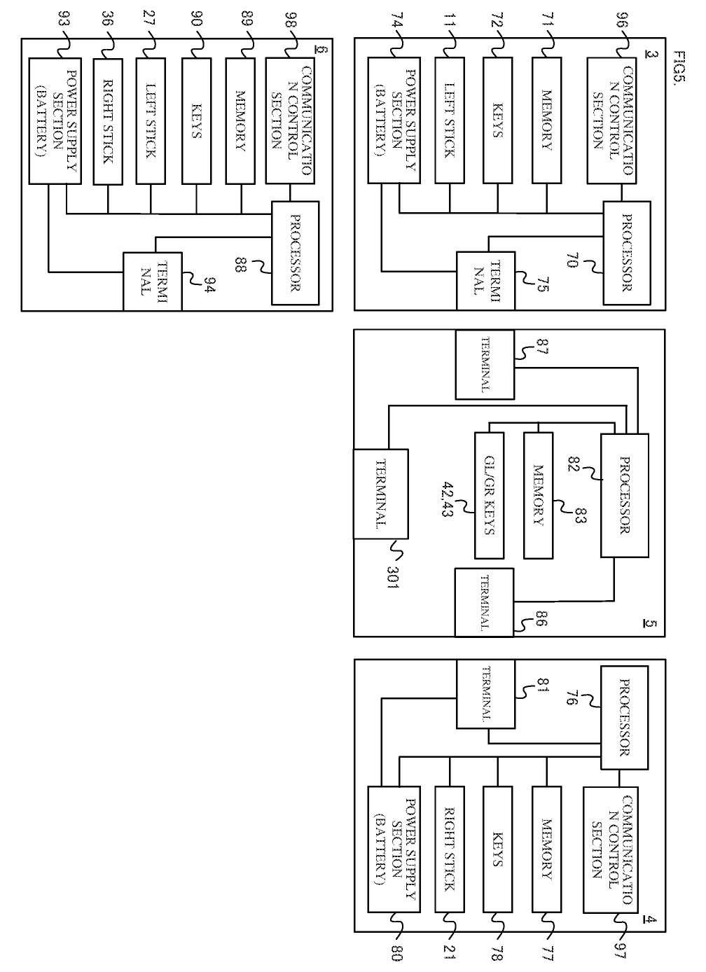

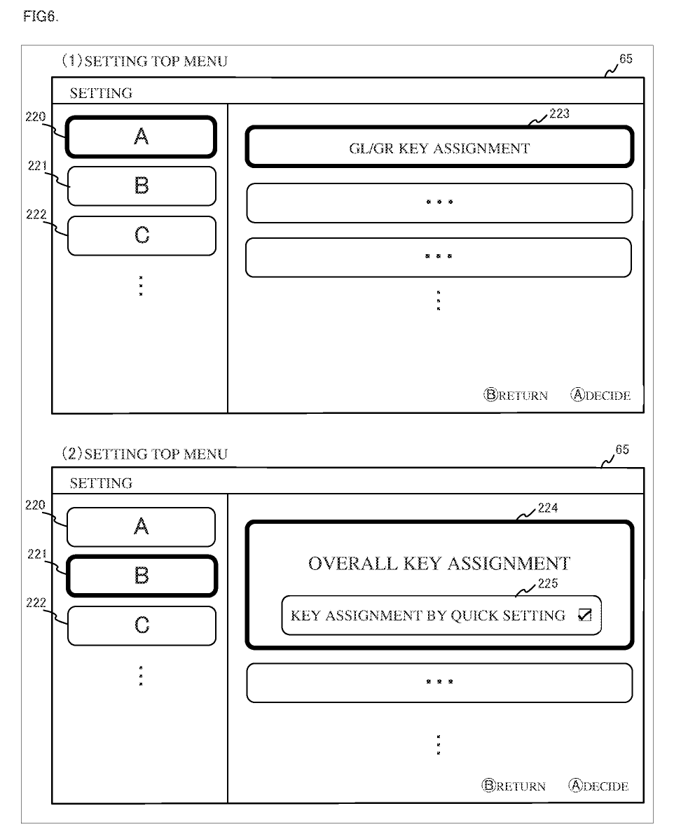

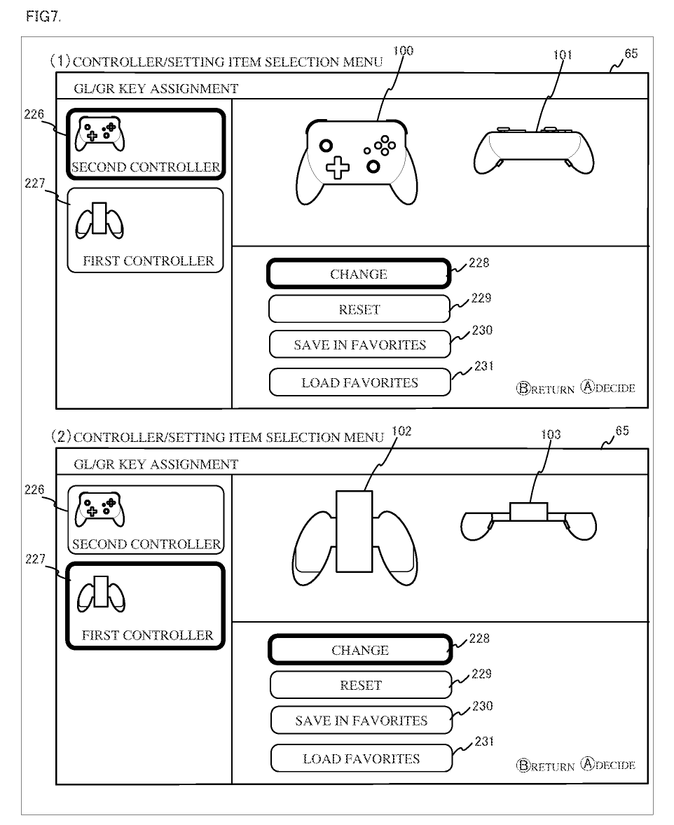

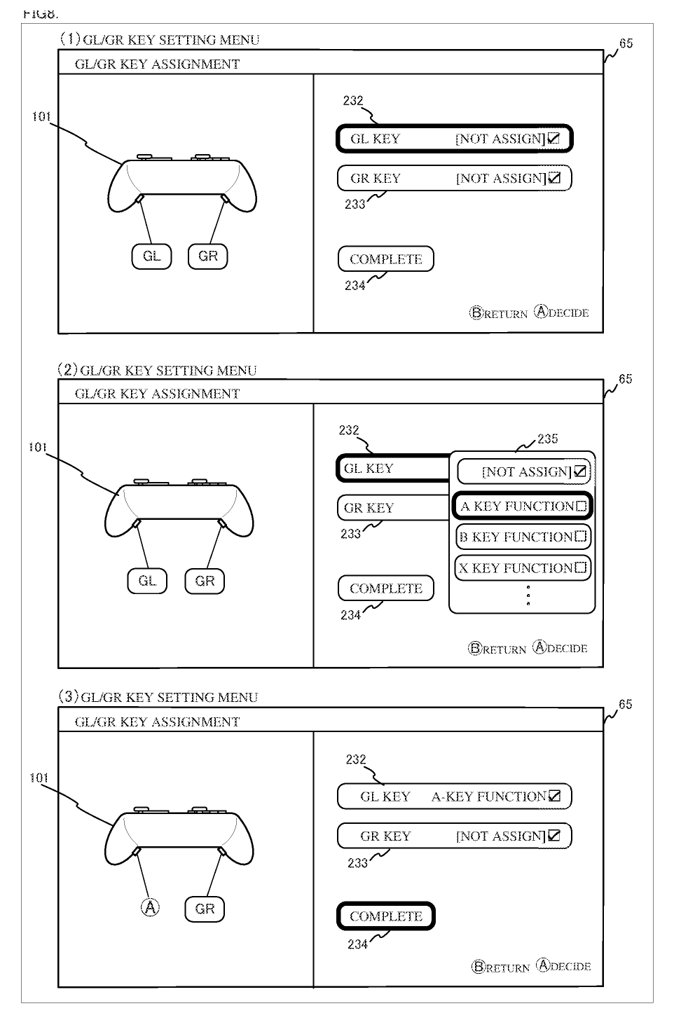

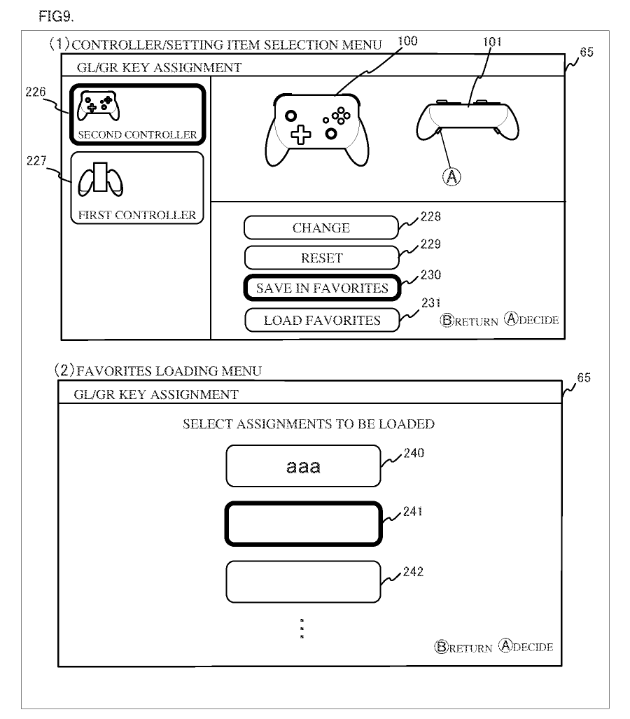

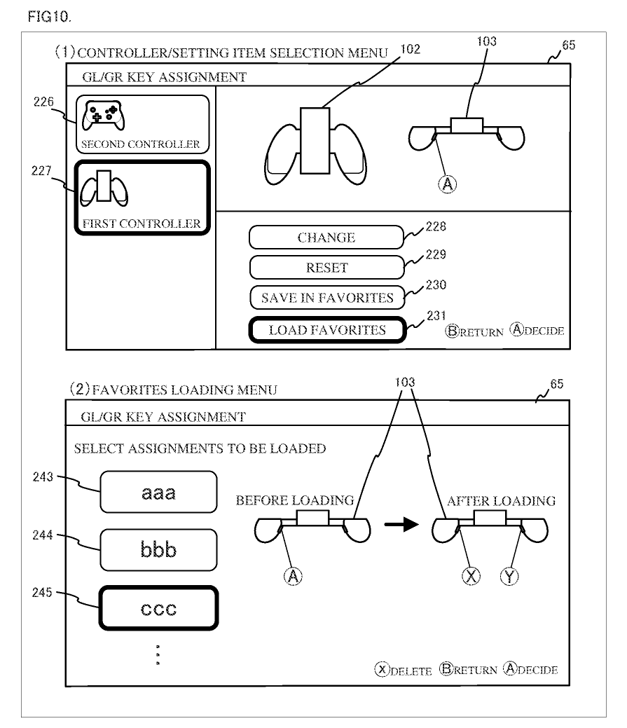

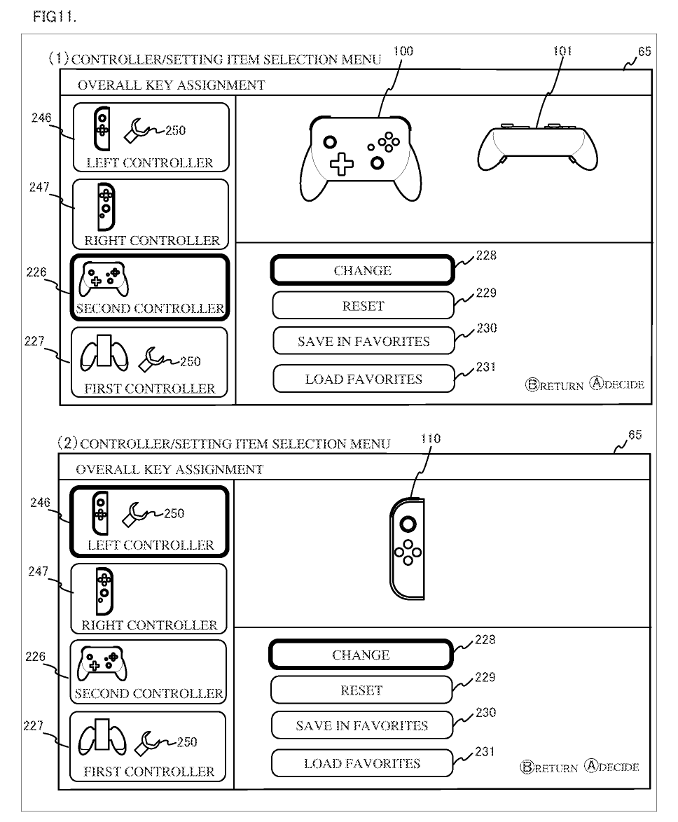

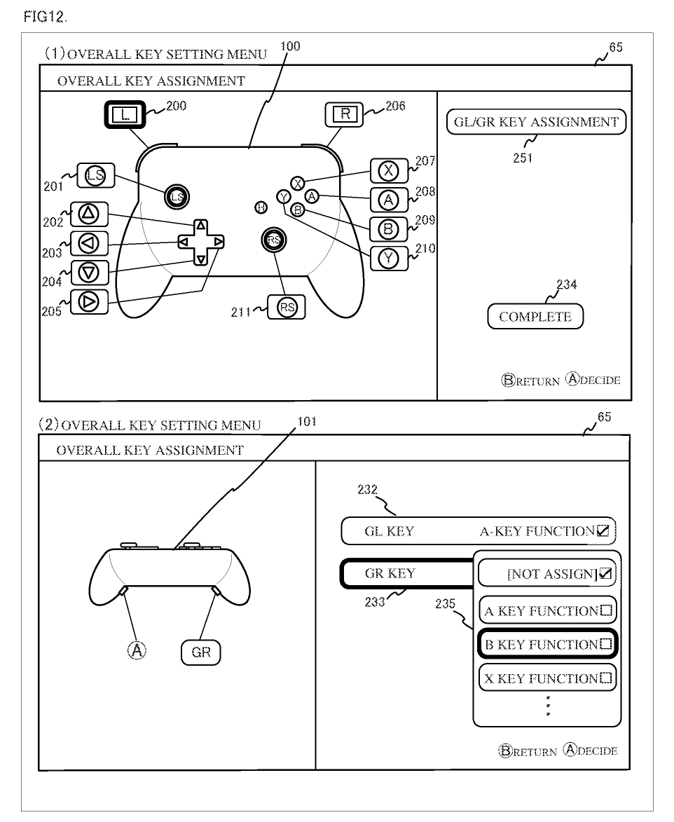

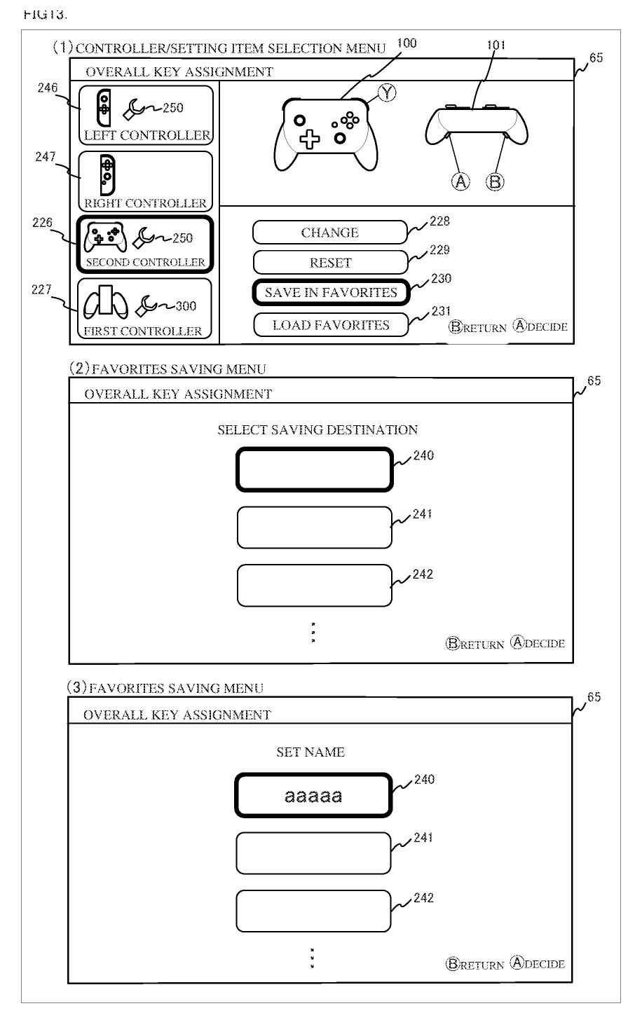

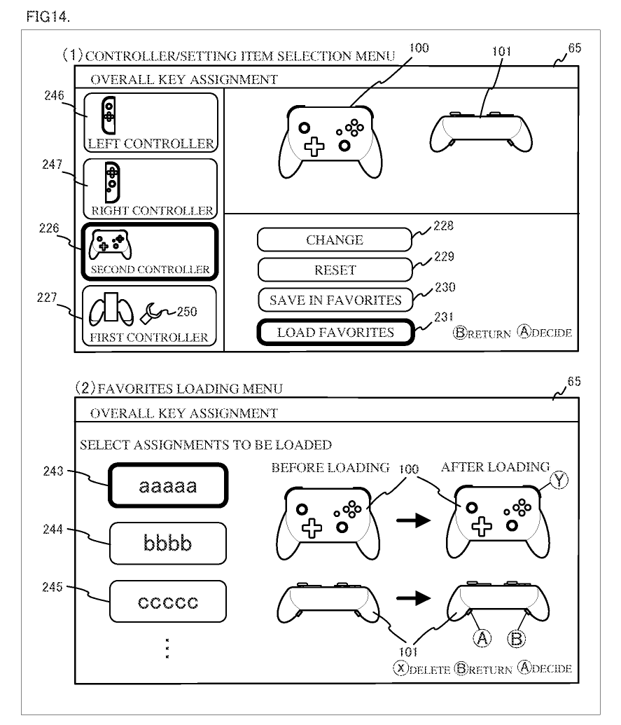

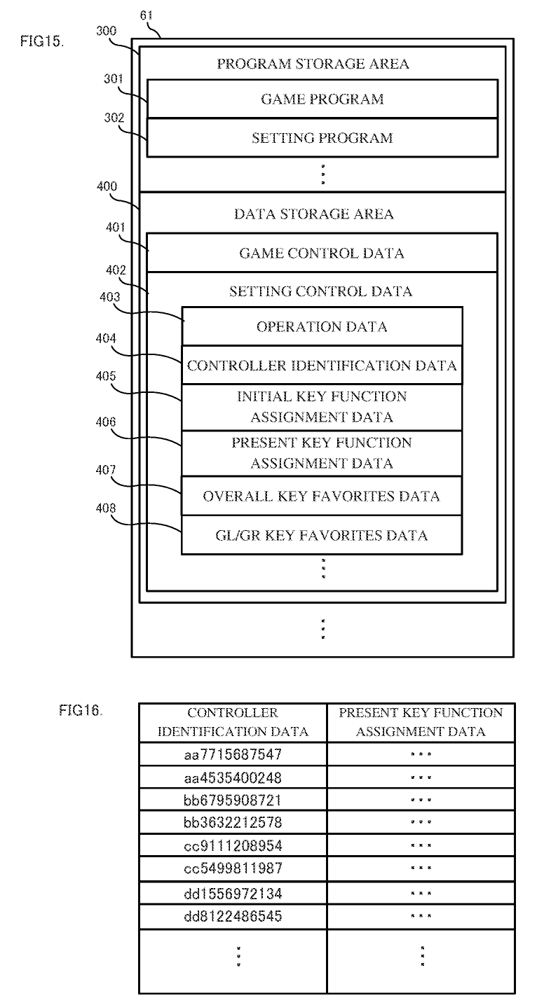

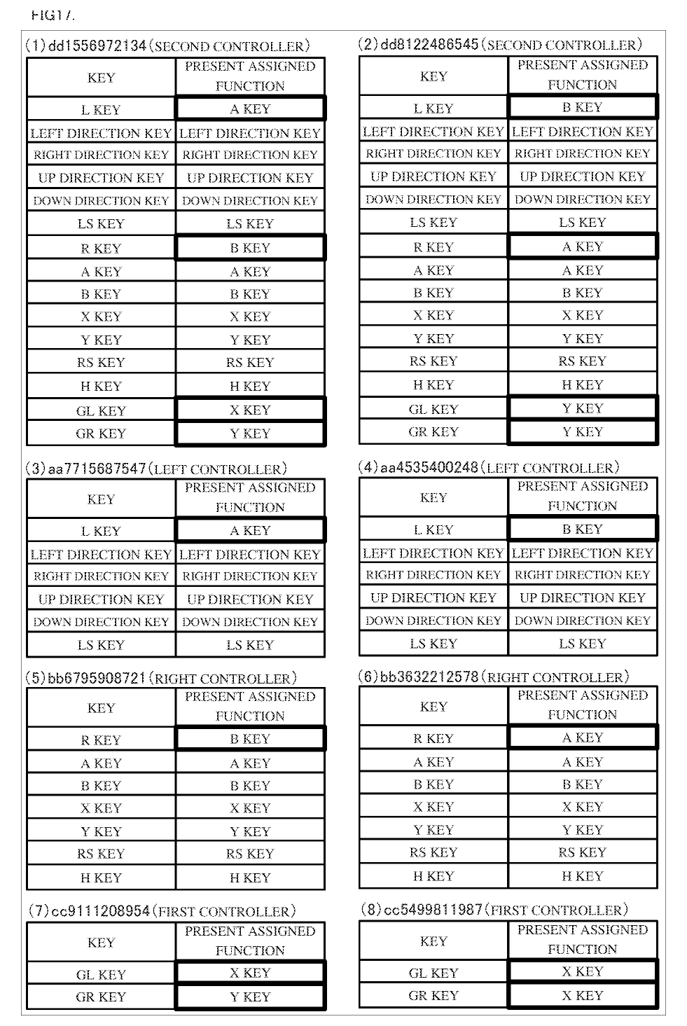

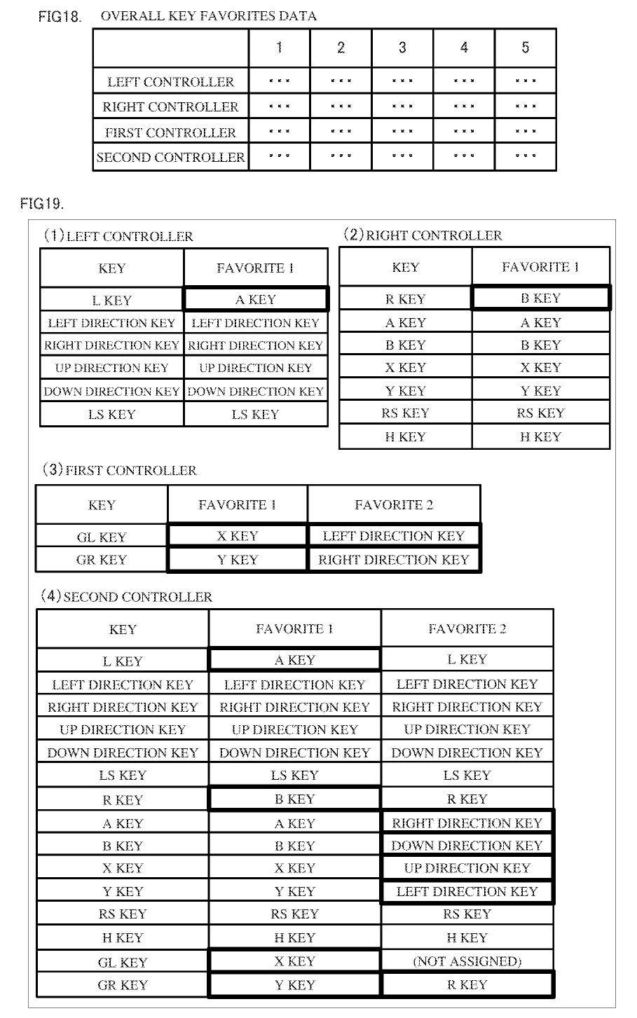

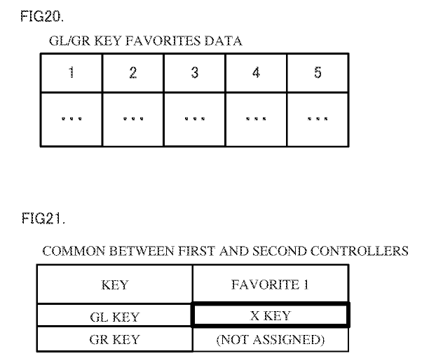

Here, a game system which is an information processing system of the exemplary embodiment will be described. As shown in FIG. 1, an example of a game system 1 in the exemplary embodiment includes an information processing apparatus (which may be referred to as a "main body apparatus") 2, and at least one controller. In the exemplary embodiment, a left controller 3, a right controller 4, a first controller 5, and a second controller 6 can be connected to the information processing apparatus 2 via a wire or wirelessly. FIG. 2(1) is a view showing a front surface of the left controller 3, and FIG. 2(2) shows a front surface of the right controller 4. FIG. 3(1) shows a front surface and a lower surface of the first controller 5 in a state in which the left controller 3 and the right controller 4 are attached, and FIG. 3(2) shows a front surface and a lower surface of the second controller 6. As shown in FIG. 3(1), the left controller 3 and the right controller 4 can be attached to the first controller 5.

In the exemplary embodiment, as an example, the game system 1 in which one first controller 5 with the left controller 3 and the right controller 4 attached thereto and one second controller 6 are connected to the main body apparatus 2, will be described. Hereinafter, the left controller 3, the right controller 4, the first controller 5, and the second controller 6 may be collectively referred to as, simply, "controllers". In another exemplary embodiment, the game system 1 may be configured such that one or more controllers among the first controllers 5 with the left controllers 3 and the right controllers 4 attached thereto and the second controllers 6 are connected to the main body apparatus 2. In another exemplary embodiment, the game system 1 may be a single information processing apparatus having controllers that are integrated therewith and are not attachable/detachable.

The main body apparatus 2 shown in FIG. 1 is a device for executing various processes (e.g., a game process and a setting process) in the game system 1. The main body apparatus 2 includes a display 65. The display 65 displays an image generated by the main body apparatus 2.

As shown in FIG. 2(1), the left controller 3 has a vertically long plate shape. The left controller 3 includes a left analog stick (which may be referred to as a "left stick") 11 which is an example of a direction input device. As shown in FIG. 2(1), the left stick 11 is provided at the front surface of the left controller 3. A user can perform direction input corresponding to a tilt direction by tilting the left stick 11, and can perform the input with a magnitude corresponding to the angle of tilt. The left stick 11 can also be used as an operation key on which a push-in operation can be performed.

The left controller 3 has various operation keys. The left controller 3 has, downward of the left stick 11, a left direction key 12, a right direction key 13, an up direction key 14, and a down direction key 15 which are provided in four directions. The left controller 3 has an L key 10 over a range between an upper surface and a left surface.

The left controller 3 has, at a right surface, a protrusion that allows the left controller 3 to be detachably attached to the main body apparatus 2. A terminal to be electrically connected to the main body apparatus is provided to the protrusion.

As shown in FIG. 2(2), the right controller 4 has a vertically long plate shape. The right controller 4 has a right analog stick (which may be referred to as a "right stick") 21 which is an example of a direction input device, as with the left stick 11. As shown in FIG. 2(2), the right stick 21 is provided at the front surface of the right controller 4.

The right controller 4 has various operation keys. The right controller 4 has, upward of the right stick 21 at the front surface, an X key 17, a Y key 18, an A key 19, and a B key 20 which are provided in four directions. A home key (H key) 22 is provided downward of the right stick 21. The right controller 4 has an R key 16 over a range between an upper surface and a right surface.

The right controller 4 has a protrusion at a left surface, as with the left controller 3.

In a direction shown in FIGS. 2(1) and (2), a user can grasp the left controller 3 by the left hand and grasp the right controller 4 by the right hand, to play a game. A user may be allowed to use the left controller 3 by grasping the left controller 3 by both hands with the right surface of the left controller 3 facing upward. A user may be allowed to use the right controller 4 by both hands with the left surface of the right controller 4 facing upward.

FIG. 3(1) is a view showing the front surface and the lower surface of the first controller 5 in a state in which the left controller 3 and the right controller 4 are attached. As shown in FIG. 3(1), the left controller 3 is attached on the left side of the first controller 5, and the right controller 4 is attached on the right side of the first controller 5. The first controller 5 is electrically connected to the attached left controller 3 and right controller 4.

The first controller 5 has a left grasp portion 23 to be grasped by the left hand of a user and a right grasp portion 24 to be grasped by the right hand of the user. A GL key 42 is provided at a back surface of the left grasp portion 23, and a GR key 43 is provided at a back surface of the right grasp portion 24.

A user grasping the first controller 5 with the left controller 3 and the right controller 4 attached thereto operates the sticks and the keys by the thumbs and operates the GL key 42 and the GR key 43 by the middle fingers and the ring fingers extending around to the back surface side, for example. The first controller 5 may not necessarily be used in a state in which the left controller 3 and the right controller 4 are not attached.

FIG. 3(2) is a view showing the front surface and the lower surface of the second controller 6. As shown in FIG. 3(2), the second controller 6 has a left grasp portion 38 to be grasped by the left hand of a user and a right grasp portion 39 to be grasped by the right hand of the user.

The second controller 6 has a left stick 27 on the left side at the front surface, and a directional pad downward thereof. The directional pad functions as a left direction key 28, a right direction key 29, an up direction key 30, and a down direction key 31. The second controller 6 has a right stick 36 on the right side at the front surface, and has, upward thereof, an X key 32, a Y key 33, an A key 34, and a B key 35 which are provided in four directions. A home key 37 is provided at a position upward of the right stick 36 and leftward of the Y key 33. The second controller 6 has an L key 25 on the left side at the upper surface, and an R key 26 on the right side at the upper surface. The second controller 6 has a GL key 40 at a back surface of the left grasp portion 38, and a GR key 41 at a back surface of the right grasp portion 39.

A user grasping the second controller 6 operates the sticks and the keys at the front surface by the thumbs and operates the GL key 40 and the GR key 41 by the middle fingers and the ring fingers extending around to the back surface side, for example.

With the configuration as described above, a user can operate the first controller 5 with the left controller 3 and the right controller 4 attached thereto and the second controller 6, in the same manner. The first controller 5 and the second controller 6 have no operable keys like a GR key and a GL key, at the back surfaces.

FIG. 4 is a block diagram showing an example of the internal configuration of the main body apparatus 2. The main body apparatus 2 includes a processor 50. The processor 50 is an information processing section which executes various information processes to be executed in the main body apparatus 2, and may be formed by one or more CPUs (Central Processing Units) or may be formed by a SoC (System-on-a-chip) including a plurality of functions such as a CPU function and a GPU (Graphics Processing Unit) function, for example. The processor 50 executes an information processing program (e.g., a game program) stored in a storage section (specifically, a memory 61, an external storage medium attached to a slot 52, etc.), to execute various information processes.

The memory 61 is a flash memory, a DRAM (Dynamic Random Access Memory), or a HDD (Hard Disk Drive), for example. The processor 50 reads and writes data from and into a storage medium such as the memory 61, as appropriate, to execute various information processes.

The main body apparatus 2 includes various components as shown in FIG. 4. Hereinafter, these will be briefly described. A network communication section 59 performs communication (e.g., Internet communication) with an external device via a network.

A wireless communication section 60 performs wireless communication (e.g., communication compliant with the Bluetooth (registered trademark) standard) with the left controller 3, the right controller 4, the first controller 5, and the second controller 6, for example. A left terminal 51 is a terminal that performs wired communication with the processor 50 and the left controller 3 by being electrically connected to a terminal 75 of the left controller 3. A right terminal 58 is a terminal that performs wired communication with the processor 50 and the right controller 4 by being electrically connected to a terminal 81 of the right controller 4. A lower terminal 57 is a terminal for, for example, outputting data (e.g., image data and sound data) to a stationary monitor or the like via a cradle when the lower terminal 57 is attached to the cradle.

A display 65 displays an image generated by the processor 50 and/or an image acquired from the outside.

FIG. 5 is a block diagram showing an example of the internal configurations of the left controller 3, the right controller 4, the first controller 5, and the second controller 6.

As shown in FIG. 5, the left controller 3 includes a communication control section 96 which performs communication with a peripheral device or the main body apparatus 2 wirelessly. The communication control section 96 and components are connected to the processor 70.

The left controller 3 includes a memory 71 such as a flash memory, for example. The processor 70 executes firmware stored in the memory 71, to execute various processes. The processor 70 acquires information about operations performed on each key 72 and the left stick 11, at appropriate timings.

The communication control section 96 transmits operation data including operation information or information obtained by performing predetermined processing on the operation information, to the main body apparatus 2 or the like. In a case where the left controller 3 is attached to the main body apparatus 2 or the like and the terminal 75 is electrically connected to the counterpart terminal, such information may be transmitted via the terminal 75 by wired communication.

As shown in FIG. 5, the right controller 4 has the same configuration as the left controller 3.

As shown in FIG. 5, the first controller 5 includes a memory 83 such as a flash memory, for example. The processor 82 executes firmware stored in the memory 83, to execute various processes.

In a state in which the terminal 75 of the left controller 3 is connected to a terminal 87 and the terminal 81 of the right controller 4 is connected to a terminal 86, the processor 82 acquires information about operations performed on the GL key 42 and the GR key 43 at appropriate timings, and transmits the acquired information to at least one of the left controller 3 and the right controller 4 via wired communication at appropriate timings. At least one of the left controller 3 and/or the right controller 4 having received information about operations from the processor 82 transmits operation data including information about operations performed on the GL key 42 and the GR key 43 or information obtained by performing predetermined processing on the operation information, to the main body apparatus 2 or the like. Therefore, for example, when the GL key 42 or the GR key 43 is operated in a state in which the left controller 3 and the right controller 4 are not attached to the first controller 5, information about the operations may not necessarily be transmitted to the main body apparatus 2 or the like.

The processor 82 may be allowed to execute processing, using power supplied from at least one of the left controller 3 and the right controller 4 attached to the first controller 5. In a case where a terminal of a power supply cable of an AC adapter or the like is connected to the terminal 301 and the processor 82 is supplied with external power, the processor 82 can perform processing using external power, and can supply power to the left controller 3 and the right controller 4 attached to the first controller 5. The left controller 3 and the right controller 4 can charge their own batteries with the supplied power.

In a case where one end of a wire cable is connected to a terminal 301 and another end is connected to the terminal 57 of the main body apparatus 2, the processor 82 may be allowed to perform processing using power supplied from the main body apparatus 2 and supply power to the left controller 3 and the right controller 4 attached to the first controller 5. In this case, the processor 82 may transmit information about operations to the main body apparatus 2 via the wire cable.

As shown in FIG. 5, the second controller 6 includes a communication control section 98 which performs communication with the main body apparatus 2 or a peripheral device. The communication control section 98 and components are connected to the processor 88.

The second controller 6 includes a memory 89 such as a flash memory, for example. The processor 88 executes firmware stored in the memory 89, to execute various processes. The processor 88 acquires information about operations performed on each key 90, the left stick 27, and the right stick 36, at appropriate timings.

The communication control section 98 transmits operation data including operation information or information obtained by performing predetermined processing on the acquired information, to the main body apparatus 2 or the like.

As with the first controller 5, the processor 88 may transmit operation information and the like to the main body apparatus 2 via a wire cable.

### [Content of Setting Process in Exemplary Embodiment]

Next, the content of the setting process in the exemplary embodiment will be described. In the exemplary embodiment, the setting process for arbitrarily assigning a key function to each key, and the like can be performed. Hereinafter, the setting process will be described with reference to FIG. 6 to FIG. 14.

As described later with reference to FIG. 16, FIG. 17, etc., keys other than the GL key 40 and the GR key 41 of the second controller 6, all the keys of the left controller 3, and all the keys of the right controller 4 are respectively assigned with the key's own functions in an initial state. For example, the L key 25 of the second controller 6 and the L key 10 of the left controller 3 are assigned with the function of the L key in the initial state. For example, the A key 34 of the second controller 6 and the A key 19 of the right controller 4 are assigned with the function of the A key in the initial state. On the other hand, the GL key 40 and the GR key 41 of the second controller 6 and the GL key 40 and the GR key 41 of the first controller 5 are assigned with no key functions in the initial state.

### [Setting Top Menu]

FIG. 6 shows an example of a "setting top menu" which appears when a predetermined operation is performed on a home menu (not shown). As shown in FIG. 6, on the setting top menu, a plurality of items such as an item 220, an item 221, and an item 222 are displayed. Then, as shown in FIG. 6(1), in a state in which the item 220 is selected, a plurality of items including an item 223 on which "GL/GR key assignment" is written are displayed. That is, when the item 220 is selected, a plurality of items corresponding to the item 220 are displayed.

As shown in FIG. 6(2), in a state in which the item 221 is selected, a plurality of items including an item 224 on which "overall key assignment" is written are displayed. That is, when the item 221 is selected, a plurality of items corresponding to the item 221 are displayed. The item 224 includes a text "key assignment by quick setting" and an item 225 on which a check mark is drawn, and this item will be described later.

In accordance with an operation on a stick or a key (e.g., the up direction key or the down direction key) assigned with a function of a direction key, a "selection switching operation" for switching an item to be selected is performed. On each menu, the item being selected is indicated by a thick frame. In a lower right area on each menu, a circle shape with "B" drawn therein and "return" at the right thereof are displayed and a circle shape with "A" drawn therein and "decide" at the right thereof are displayed. These indicate that a "return operation" for returning to a one-level higher-order menu can be performed by operating a key assigned with the function of the B key, and a "decision operation" can be performed by operating a key assigned with the function of the A key.

Hereinafter, a sequence of shifting by entering from the "GL/GR key assignment" item 223 shown in FIG. 6(1) may be referred to as a "GL/GR key assignment sequence". In addition, a sequence of shifting by entering from the "overall key assignment" item 224 shown in FIG. 6(2) may be referred to as an "overall key assignment sequence".

### [Controller/Setting Item Selection Menu in GL/GR Key Assignment Sequence]

FIG. 7 shows an example of the "controller/setting item selection menu" for selecting setting items regarding only the GL key and the GR key in the GL/GR key assignment sequence. As shown in FIG. 6(1), when a decision operation is performed in a state in which the "GL/GR key assignment" item 223 is selected, the screen shifts to the controller/setting item selection menu shown in FIG. 7. As shown in FIG. 7, on the left side of the controller/setting item selection menu, an image of the second controller and an item 226 on which a text "second controller" is written, and an image of the first controller and an item 227 on which a text "first controller" is written, are displayed.

Here, on the left side of the controller/setting item selection menu shown in FIG. 7, the item 226 including the image of the second controller is displayed in a case where the second controller is connected to the main body apparatus 2 (either via a wire or wirelessly; hereafter, the same applies), and the item 227 including the image of the first controller alone is displayed in a case where the first controller with the left controller and the right controller attached thereto is connected to the main body apparatus 2. In FIG. 7, a case where one second controller, and one first controller with the left controller and the right controller attached thereto, are connected to the main body apparatus 2, is shown.

As shown in FIG. 7(1), in a state in which the item 226 is selected, a front surface image 100 and a lower surface image 101 of the second controller are displayed, and an item 228 on which "change" is written, an item 229 on which "reset" is written, an item 230 on which "save in favorites" is written, and an item 231 on which "load favorites" is written, are displayed. That is, when the item 226 is selected, setting items relevant to the GL key and the GR key of the second controller are displayed for selection. On the other hand, as shown in FIG. 7(2), in a state in which the item 227 is selected, a front surface image 102 and a lower surface image 103 of the first controller are displayed, and items 228 to 231 are displayed. That is, when the item 227 is selected, setting items relevant to the GL key and the GR key of the first controller are displayed for selection.

### [GL/GR Key Setting Menu in GL/GR Key Assignment Sequence]

FIG. 8 shows an example of a "GL/GR key setting menu" for assigning key functions to only the GL key and the GR key of the second controller in the GL/GR key assignment sequence. As shown in FIG. 7(1), when, in a state in which the item 226 is selected, a "change" item 228 is selected and a decision operation is performed thereon, the screen shifts to the GL/GR key setting menu shown in FIG. 8. As shown in FIG. 8(1), on the GL/GR key setting menu, a lower surface image 101 of the second controller, an item 232 on which "GL key" is written, an item 233 on which "GR key" is written, and an item 234 on which "completion" is written, are displayed.

Here, a text "not assign" and a check mark are drawn on the "GL key" item 232, and this indicates that no key function is assigned to the GL key. Similarly, a text "not assign" and a check mark are drawn also on the "GR key" item 233, and this indicates that no key function is assigned to the GR key. At the lower surface image 101 of the second controller, an image on which a text "GL" indicating the position of the GL key is written and an image on which a text "GR" indicating the position of the GR key is written, are added.

When a decision operation is performed in a state in which the "GL key" item 232 is selected as shown in FIG. 8(1), an item 235 composed of an item on which "not assign" is written and a plurality of items on which the functions of keys other than the GL key and the GR key are written, is displayed as shown in FIG. 8(2). Then, by switching selection among the items composing the item 235 through a selection switching operation, a user can select an assignment of the key function to the GL key.

In FIG. 8(2), selection for an assignment of the function of the A key to the GL key is performed. Then, when a decision operation is performed in the state of FIG. 8(2), the item 235 disappears and a text "A-key function" and a check mark are drawn on the "GL key" item 232, as shown in FIG. 8(3). In addition, a "GL" image indicating the position of the GL key of the lower surface image 101 of the second controller is switched to an image on which "A" is written.

Although not shown, also for the GR key, an assignment of the key function can be arbitrarily selected using the "GR key" item 233, in the same manner. In FIG. 8(3), the GR key remains assigned with no key function.

Thereafter, in a state in which the "completion" item 234 is selected as shown in FIG. 8(3), when a decision operation is performed, the GL key is set to be assigned with the A-key function, and the GR key is set to be assigned with no key function.

As described later with reference to FIG. 16, FIG. 17, etc., an assignment of a key function is set for each individual controller. That is, an assignment of a key function is set for each of individual controllers even if these controllers are the same type.

As shown in FIG. 7(2), when, in a state in which the item 227 is selected, the "change" item 228 is selected and a decision operation is performed thereon, the screen shifts to a "GL/GR key setting menu" (not shown) for assigning key functions to only the GL key and the GR key of the first controller. The GL/GR key setting menu for the first controller is configured such that the lower surface image 101 of the second controller on the GL/GR key setting menu for the second controller is replaced with the lower surface image 103 of the first controller (see FIG. 7(2)). On the GL/GR key setting menu for the first controller, by performing a setting operation as described above with reference to FIG. 8, setting of key functions for the GL key and the GR key of the first controller can be performed in the same manner.

### [Favorites Saving Menu in GL/GR Key Assignment Sequence]

FIG. 9 illustrates a "favorites saving menu" for saving key functions assigned to the GL key and the GR key in the GL/GR key assignment sequence, as favorites.

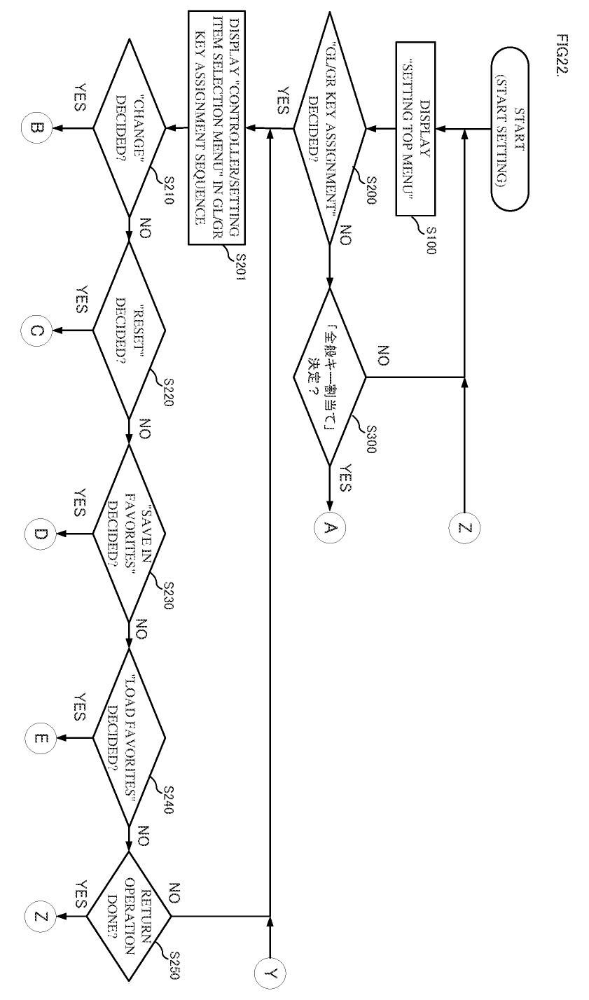

As described later with reference to FIG. 20, FIG. 21, etc., favorites data of a key function set saved using the "favorites saving menu" in the GL/GR key assignment sequence is stored as common data without being discriminated between the second controller and the first controller.

As shown in FIG. 9(1), on the controller/setting item selection menu in the GL/GR key assignment sequence, when, in a state in which a "second controller" item 226 is selected, a "save in favorites" item 230 is selected and a decision operation is performed, the screen shifts to a favorites saving menu shown in FIG. 9(2).

Here, on the controller/setting item selection menu in the GL/GR key assignment sequence, in a case where a key function different from the initial assigned key function is assigned to the GL key and/or the GR key at present, an indication that the different key function is assigned is displayed. In the initial state, the GL key and the GR key are assigned with no key functions, and in the case of FIG. 9(1), the function of the A key is assigned to the GL key at present. Accordingly, as shown in FIG. 9(1), an indication (a circular shape with a text "A" drawn therein) that the function of the A key is assigned is displayed at the GL key of the lower surface image 101 of the second controller.

As shown in FIG. 9(2), on the favorites saving menu, a text "select saving destination", a plurality of items 240 to 242 indicating saving destinations of the key function set assigned to the GL key and the GR key at present, and the like are displayed. Here, on an item 240 in which a key function set has already been saved, a name "aaa" of the saved key function set is displayed. Then, as shown in FIG. 9(2), when the item 241 in which no key function set is saved is selected and a decision operation is performed thereon, the screen shifts to a name input screen. On the name input screen, if, for example, "bbb" is inputted, the key function set assigned to the GL key and the GR key at present is saved as a favorite "bbb". On the favorites saving menu, the key function set "aaa" which has already been saved can be overwritten.

On the controller/setting item selection menu in the GL/GR key assignment sequence, also when, in a state in which the "first controller" item 227 is selected, the "save in favorites" item 230 is selected and a decision operation is performed thereon (not shown), similarly, the screen shifts to the favorites saving menu shown in FIG. 9(2). In a case where the "save in favorites" item 230 is entered from the "second controller" item 226 and then the favorite "bbb" is set as described above, next, if the "save in favorites" item 230 is entered from the "first controller" item 227, the "aaa" item 240 and the "bbb" item 241 are displayed. On the controller/setting item selection menu in the GL/GR key assignment sequence, when the "first controller" item 227 is selected, the images 102 and 103 of the first controller (see FIG. 7(2)) are displayed instead of the images 100 and 101 of the second controller shown in FIG. 9(1), and an indication for a key for which the assignment of the key function has been changed from the initial state is also displayed. Then, when an operation as described above with reference to FIG. 9(2) is performed, a key function set assigned to the GL key and the GR key of the first controller is saved as a favorite.

### [Favorites Loading Menu in GL/GR Key Assignment Sequence]

FIG. 10 illustrates a "favorites loading menu" for loading a key function set for the GL key and the GR key saved as a favorite in the GL/GR key assignment sequence.

As shown in FIG. 10(1), on the controller/setting item selection menu in the GL/GR key assignment sequence, when, in a state in which the "first controller" item 227 is selected, a "load favorites" item 231 is selected and a decision operation is performed thereon, the screen shifts to the favorites loading menu shown in FIG. 10(2). In FIG. 10(1), an indication (a circular shape with a text "A" drawn therein) that the function of the A key is assigned to the GL key of the lower surface image 103 of the first controller at present is displayed.

As shown in FIG. 10(2), on the favorites loading menu, a text "select assignment to be loaded", a plurality of items 243 to 245, etc., indicating key function sets for the GL key and the GR key saved as favorites with their names added thereto, a lower surface image 103 of the first controller indicating key function assignments of the GL key and the GR key before a favorite key function set is loaded (which may be referred to as "present key function assignments"), and a lower surface image 103 of the first controller indicating key function assignments of the GL key and the GR key after the favorite key function set is loaded (which may be referred to as "key function assignments after favorites loading"), are displayed.

In FIG. 10(2), the item 245 with a name "ccc" added as a favorite is selected. Then, in FIG. 10(2), as the present key function assignments, an image 103 indicating that the GL key is assigned with the A-key function and the GR key is assigned with no key function, is displayed, and as the key function assignments after favorites loading corresponding to the item 245, an image 103 indicating that the GL key is assigned with the X-key function and the GR key is assigned with the Y-key function, is displayed.

Then, when a decision operation is performed in a state in which the item 245 is selected, the favorite key function set corresponding to the item 245 is loaded and set as present key function assignments of the GL key and the GR key.

As shown in FIG. 10(2), on the lower side of the favorites loading menu, a circular shape with "X" drawn therein and a text "delete" at the right thereof are displayed. This indicates that the favorite for the selected item (e.g., item 245) can be deleted by operating the key assigned with the function of the X key.

On the controller/setting item selection menu in the GL/GR key assignment sequence, also when, in a state in which the "second controller" item 226 is selected, the "load favorites" item 231 is selected and a decision operation is performed thereon (not shown), similarly, the screen shifts to the favorites loading menu shown in FIG. 10(2). At this time, favorites that can be loaded are the same as the favorites that can be loaded by proceeding from the "first controller" item 226. In this case, the images 100 and 101 (see FIG. 7(1)) of the second controller are displayed instead of the images 102 and 103 of the first controller shown in FIGS. 10(1) and 10(2). Then, when an operation as described above with reference to FIG. 10(2) is performed, a desired favorite key function set is loaded and set as present key function assignments of the GL key and the GR key.

### [Reset Menu in GL/GR Key Assignment Sequence]

On the controller/setting item selection menu in the GL/GR key assignment sequence, when, in a state in which the "second controller" item 226 is selected (see FIG. 7(1)), an item 229 on which "reset" is written is selected and a decision operation is performed thereon, a reset menu (not shown) is displayed. On the reset menu, an item on which "reset assignments of GL key and GR key" is written is displayed. Then, when a decision operation is performed in a state in which this item is selected, the states of assignments of the key functions to the GL key and the GR key of the second controller are reset to the initial states of assignments of the key functions (i.e., a state in which no key function is assigned). The same applies to the "first controller" item 227.

### [Controller/Setting Item Selection Menu in Overall Key Assignment Sequence]

FIG. 11 shows an example of a "controller/setting item selection menu" for selecting setting items relevant to overall keys in the overall key assignment sequence. When a decision operation is performed in a state in which the "overall key assignment" item 224 is selected as shown in FIG. 6(2), the screen shifts to the controller/setting item selection menu shown in FIG. 11. As shown in FIG. 11, items indicating controllers connected to the main body apparatus 2 are displayed on the left side of the controller/setting item selection menu.

In a case where key function assignment setting has been changed from the initial state, a wrench mark 250 may be displayed on the item indicating the corresponding controller being connected. In FIG. 11, since key function assignment settings for the left controller and the first controller have been changed from the initial states, wrench marks 250 are displayed on items 246 and 227. On the controller/setting item selection menu in the GL/GR key assignment sequence (see FIG. 7), a wrench mark 250 may not necessarily be displayed even when the GL/GR key is assigned with any key function. In addition, even if a wrench mark 250 is displayed for a controller in the overall key assignment sequence, a wrench mark 250 may not necessarily be displayed for the controller on the controller/setting item selection menu in the GL/GR key assignment sequence (see FIG. 7). The wrench mark is merely an example, and an identifiable mark or display manner may be employed as appropriate.

Here, on the left side of the controller/setting item selection menu shown in FIG. 11, the item 226 including an image of the second controller is displayed in a case where the second controller is connected to the main body apparatus 2, and the item 246 including an image of the left controller, an item 247 including an image of the right controller, and the item 227 including an image of the first controller alone, are displayed in a case where the first controller with the left controller and the right controller attached thereto is connected to the main body apparatus 2. In FIG. 11, a case where one second controller, and one first controller with the left controller 3 and the right controller 4 attached thereto, are connected to the main body apparatus 2, is shown. For example, also in a case where the left controller 3 and the right controller 4 are each independently connected to the main body apparatus 2 wirelessly, the left controller 3 and the right controller 4 are displayed as in FIG. 11. That is, irrespective of whether or not the left controller 3 and the right controller 4 are attached to the first controller 5, each of the left controller 3 and the right controller 4 is individually displayed and can be selected.

As shown in FIG. 11(1), in a state in which the "second controller" item 226 is selected, the front surface image 100 and the lower surface image 101 of the second controller are displayed, and an item 228 on which "change" is written, an item 229 on which "reset" is written, an item 230 on which "save in favorites" is written, and an item 231 on which "load favorites" is written, are displayed. That is, when the item 226 is selected, a screen for selecting setting items relevant to all the keys of the second controller is displayed.

As shown in FIG. 11(2), in a state in which the "left controller" item 246 is selected, a front surface image 110 of the left controller is displayed, and items 228 to 231 are displayed. The same applies to a case where the "right controller" item 247 is selected. In a case where the "first controller" item 227 is selected, the same applies except that a lower surface image is displayed in addition to a front surface image.

### [Overall Key Setting Menu in Overall Key Assignment Sequence]

FIG. 12 shows an example of an "overall key setting menu" for assigning key functions to all the keys excluding the H key 37 of the second controller in the overall key assignment sequence. As shown in FIG. 11(1), when, in a state in which the item 226 is selected, the "change" item 228 is selected and a decision operation is performed thereon, the screen shifts to the overall key setting menu shown in FIG. 12. The overall key setting menu is composed of an upper-layer menu shown in FIG. 12(1) to which the screen shifts from the controller/setting item selection menu shown in FIG. 11, and a lower-layer menu shown in FIG. 12(2) which is shifted to/from the upper-layer menu.

As shown in FIG. 12(1), on the upper-layer menu of the overall key setting menu, the front surface image 100 of the second controller, an item 251 on which "GL/GR key assignment" is written, and an item 234 on which "completion" is written, are displayed. With the front surface image 100 of the second controller, items 200 to 211 indicating the key functions assigned to the keys excluding the H key 37 at present, are displayed.

When the "GL/GR key assignment" item 251 is selected and a decision operation is performed thereon, the lower-layer menu shown in FIG. 12(2) appears. As shown in FIG. 12(2), on the lower-layer menu, the lower surface image 101 of the second controller and an item 232 on which "GL key" is written, and an item 233 on which "GR key" is written, are displayed. In a state in which the lower-layer menu is displayed, if a return operation is performed, the screen shifts to the upper-layer menu.

Then, when a decision operation is performed in a state in which the "GR key" item 233 is selected, as shown in FIG. 12(2), an item on which "not assign" is written and an item 235 composed of a plurality of items on which functions of keys including the H key 37, other than the GL key and the GR key, are displayed. Then, by switching selection among the items composing the item 235 through selection switching operation, a user can select an assignment of a key function to the GR key.

In FIG. 12(2), selection for an assignment of the B key to the GR key is performed. Then, when a decision operation is performed in the state of FIG. 12(2), the item 235 disappears and a text "B-key function" and a check mark are drawn on the "GR key" item 233. In addition, a "GR" image indicating the position of the GR key of the lower surface image 101 of the second controller is switched to an image on which "B" is written. For the GL key, a similar operation has been performed using the "GL key" item 232, and thus selection of assigning the A-key function has already been performed.

Also for keys excluding the H key 37 other than the GL key and the GR key of the second controller, any of key functions including the key function of the H key 37 can be assigned. On the upper-layer menu shown in FIG. 12(1), for example, by performing a similar operation using the item 210, an assignment of a desired key function to the Y key can be selected. Selection of assigning no key function may not necessarily be allowed for keys other than the GL key and the GR key of the second controller.

Then, on the upper-layer menu shown in FIG. 12(1), when a decision operation is performed in a state in which the "completion" item 234 is selected, the contents of selections of key functions performed for respective keys are set. That is, change of assignments of the key functions is set for the second controller.

Also in a case where the item 246 or 247 shown in FIG. 11(2) is selected, similarly, key functions including the function of the H key can be assigned to all the keys excluding the H key.

In the above description, the H key is not assigned with another key function. However, in another exemplary embodiment, other key functions may be allowed to be assigned to all the keys including the H key.

On the controller/setting item selection menu, also when, in a state in which the item 227 is selected, the "change" item 228 is selected and a decision operation is performed thereon, the screen shifts to an "overall key setting menu" (not shown) for assigning key functions to all the keys (i.e., the GL key and the GR key) of the first controller. For the GL keys and the GR keys of the second controller and the first controller, setting of assigning no key function can be performed.

### [Favorites Saving Menu in Overall Key Assignment Sequence]

FIG. 13 illustrates a "favorites saving menu" for saving, as a favorite, key functions assigned to respective keys in the overall key assignment sequence.

As described later with reference to FIG. 18, FIG. 19, etc., favorites data of key function sets saved using the "favorites saving menu" in the overall key assignment sequence is stored as data for each type of the controllers so as to be discriminated on a controller type basis.

As shown in FIG. 13(1), on the controller/setting item selection menu in the overall key assignment sequence, when, in a state in which the "second controller" item 226 is selected, the "save in favorites" item 230 is selected and a decision operation is performed thereon, the screen shifts to a favorites saving menu shown in FIG. 13(2).

Here, on the controller/setting item selection menu in the overall key assignment sequence, in a case where key functions different from the key functions assigned in the initial state are assigned to one or more keys at present, indications for assignments of the different key functions are displayed. In the case of FIG. 13(1), at present, the R key is assigned with the function of the Y key, the GL key is assigned with the function of the A key, and the GR key is assigned with the function of the B key. Accordingly, as shown in FIG. 13(1), an indication that the function of the Y key is assigned is displayed at the R key of the front surface image 100 of the second controller, an indication that the function of the A key is assigned is displayed at the GL key of the lower surface image 101 of the second controller, and an indication that the function of the B key is assigned is displayed at the GR key of the lower surface image 101 of the second controller.

As shown in FIG. 13(2), on the favorites saving menu, a text "select saving destination", a plurality of items 240 to 242 indicating saving destinations of the key function set assigned to the GL key and the GR key at present, and the like are displayed. On an item in which a key function set has already been saved, the name of the saved key function set is displayed. Then, as shown in FIG. 13(2), when the item 240 in which no key function set is saved is selected and a decision operation is performed thereon, the screen shifts to a name input screen. On the name input screen, when a name is inputted, the key function set assigned to all the keys excluding the H key of the second controller at present is saved as a favorite.

On the controller/setting item selection menu in the overall key assignment sequence, also when, in a state in which one of the "left controller" item 246, the "right controller" item 247, and the "first controller" item 227 is selected, the "save in favorites" item 230 is selected and a decision operation is performed thereon (not shown), similarly, the screen shifts to the favorites saving menu shown in FIG. 13(2). Then, by performing an operation as described above with reference to FIG. 13(2), the key function set assigned to respective keys at present is saved as a favorite.

### [Favorites Loading Menu in Overall Key Assignment Sequence]

FIG. 14 illustrates a "favorites loading menu" for loading a key function set saved as a favorite in the overall key assignment sequence.

As shown in FIG. 14(1), on the controller/setting item selection menu in the overall key assignment sequence, when, in a state in which the "second controller" item 226 is selected, the "load favorites" item 231 is selected and a decision operation is performed thereon, the screen shifts to the favorites loading menu shown in FIG. 14(2). In FIG. 14(1), since assignments of the key functions have not been changed from the initial state, indications that assignments of key functions have been changed from the initial state are not displayed at the images 100 and 101 of the second controller.

As shown in FIG. 14(2), on the favorites loading menu, a text "select assignment to be loaded", a plurality of items 243 to 245 indicating key function sets saved as favorites with their names added thereto, and the like, are displayed. In addition, on the favorites loading menu, images 100 and 101 of the second controller indicating key function assignments before a favorite key function set is loaded (which may be referred to as "present key function assignments"), and images 100 and 101 of the second controller indicating key function assignments after the favorite key function set is loaded (which may be referred to as "key function assignments after favorites loading"), are displayed.

In FIG. 14(2), the item 243 with a name "aaaaa" added as a favorite is selected. In addition, the images 100 and 101 indicating that the present key function assignments are the initial key assignments, and as the key function assignments after favorites loading corresponding to the item 243, the images 100 and 101 indicating that the R key is assigned with the Y-key function, the GL key is assigned with the A-key function, and the GR key is assigned with the B-key function, are displayed.

Then, when a decision operation is performed in a state in which the item 243 is selected, the favorite key function set corresponding to the item 243 is loaded and set as present key function assignments.

On the favorites loading menu shown in FIG. 14(2), as in the favorites loading menu shown in FIG. 10(2), an indication that the favorite for the selected item (e.g., item 243) can be deleted by operating the key assigned with the function of the X key, is displayed.

On the controller/setting item selection menu in the overall key assignment sequence, also when, in a state in which one of the "left controller" item 246, the "right controller" item 247, and the "first controller" item 227 is selected, the "load favorites" item 231 is selected and a decision operation is performed thereon (not shown), similarly, the screen shifts to the favorites loading menu. Then, on the favorites loading menu corresponding to each controller, similarly, a desired favorite key function set is loaded and set as present key function assignments, in accordance with operations.

### [Quick Setting]

In the exemplary embodiment, in a period during execution of the above setting process, a period during execution of a game, and another period, for example, by performing a hold-down operation on a key assigned with the H-key function, a quick setting window (not shown) is displayed. On the quick setting window, an item on which "RL/GR key assignment" is written is displayed. Then, when the item on which "RL/GR key assignment" is written is executed, the controller/setting item selection menu in the RL/GR key assignment sequence (see FIG. 7) is displayed and setting for RL/GR key assignment can be performed.

As shown in FIG. 6(2), on the item 225 on which "key assignment by quick setting" is written, which is included in the "overall key assignment" item 224, a check mark is displayed as a result of a predetermined operation being performed. Then, in the setting state in which a check mark is displayed on the item 225, an item on which "overall key assignment" is written is added in the above quick setting window. Then, when the item on which "overall key assignment" is written is executed, the controller/setting item selection menu in the overall key assignment sequence (see FIG. 11) is displayed and setting for overall key assignment can be performed. As described above, through the quick setting, it is possible to easily access the controller/setting item selection menu in the RL/GR key assignment sequence and the controller/setting item selection menu in the overall key assignment sequence.

In a case where the controller/setting item selection menu is accessed through the quick setting, the controller/setting item selection menu may be displayed in a state in which the item for the controller being operated is selected and the "change" item is selected. For example, in a case where the controller/setting item selection menu in the overall key assignment sequence is accessed through the quick setting, a second controller/setting item selection menu may be displayed in a state in which the item 226 of the second controller being operated is selected and the "change" item is selected (see FIG. 11(1)). Further, in the case where the controller/setting item selection menu is accessed through the quick setting, the overall key setting menu (see FIG. 12) in a layer under the controller/setting item selection menu or the RL/GR key (see FIG. 8) may be displayed.

On the quick setting window, a user may select any of controllers connected to the main body apparatus 2, and the controller/setting item selection menu of the selected controller may be displayed.

### [Details of Information Processing in Exemplary Embodiment]

Next, with reference to FIG. 15 to FIG. 25, information processing in the exemplary embodiment will be described in detail.

### [Used data]

Various data used in the information processing will be described. FIG. 15 shows an example of data stored in the memory 61 of the main body apparatus 2. As shown in FIG. 15, the memory 61 is provided with at least a program storage area 300 and a data storage area 400. In the program storage area 300, a game program 301, a setting program 302, and the like are stored. In the data storage area 400, game control data 401, setting control data 402, and the like are stored. The setting control data 402 includes operation data 403, controller identification data 404, initial key function assignment data 405, present key function assignment data 406, overall key favorites data 407, and GL/GR key favorites data 408.

The game program 301 is a game program for executing game processing.

The setting program 302 is a program for executing various settings such as changing assignments of key functions.

The game control data 401 is data needed for executing the game processing.

The setting control data 402 is data needed for executing the setting process.

The operation data 403 is operation data indicating the contents of operations performed on the left controller 3, the right controller 4, the first controller 5, and the second controller 6.

The controller identification data 404 is data for identifying controllers, and is used for identifying the types of controllers and individual units of controllers. In the controller identification data 404, data unique to the individual controller, acquired from the controller when the controller is connected to the main body apparatus 2, is stored within a range not exceeding a predetermined number.

The initial key function assignment data 405 is data in which, for each type of controllers, key functions (which may be referred to as "initial assigned functions") assigned in the initial state are associated with respective keys of the controller. In the initial key function assignment data 405, the GL keys and the GR keys of the first controller 5 and the second controller 6 are assigned with no key functions.

The present key function assignment data 406 is data in which key functions assigned at present (which may be referred to as "present assigned functions") are associated with respective keys of each controller. When a key assignment of an individual controller is changed, the present key function assignment data 406 is updated to the changed assignment. The present key function assignment data 406 may remain stored even after the corresponding controller is disconnected from the main body apparatus 2. In this case, the next time the controller is connected to the main body apparatus 2, the stored present key function assignment data 406 may be applied. In a case where an assignment of a key function has not changed for any of the keys of the connected controller, the present key function assignment data 406 may be deleted when the controller is disconnected, or may not be generated in the first place.

FIG. 16 schematically illustrates the relationship between the controller identification data 404 and the present key function assignment data 406. As shown in FIG. 16, the controller identification data 404 is data of twelve characters composed of two alphabets on the left side and remaining ten numbers, for example, and the controller identification data 404 and the present key function assignment data 406 are associated with each other one by one. In the controller identification data 404, for example, two alphabets on the left side represent the type of each controller, and "aa" represents the left controller, "bb" represents the right controller, "cc" represents the first controller, and "dd" represents the second controller.

FIG. 17 schematically shows specific examples of the present key function assignment data 406 of controllers. In FIG. 17, the present assigned functions (i.e., key functions changed from the initial key functions) different from the initial assigned functions are indicated by thick frames. For example, the controller identification data "dd1556972134" shown in FIG. 16 is associated with the present key function assignment data shown in FIG. 17(1), the controller corresponding to this controller identification data is the second controller, and the second controller is in the key function assignment state shown in FIG. 17(1). The present key function assignment data 406 is generated for each individual controller, and therefore, as shown in FIG. 17, for example, even when there are left controllers of the same type, if they are different individual units, different present key function assignment data 406 exist. In the present key function assignment data 406, the H key is also included, but the H key may not necessarily be included. The present key function assignment data 406 may be data indicating assignments of only keys assigned with key functions different from the initial ones.

The overall key favorites data 407 is data in which sets of favorite assigned key functions (which may be referred to as "favorite key functions") can be saved up to a predetermined number for each type of controllers. The overall key favorites data 407 is used when favorites saving is performed in the overall key assignment sequence (see FIG. 13) and when favorites loading is performed in the overall key assignment sequence (see FIG. 14).

FIG. 18 schematically shows a specific example of the overall key favorites data 407. As shown in FIG. 18, in the overall key favorites data 407, up to five sets of favorite key functions (which may be simply referred to as "favorites") may be allowed to be saved for each type of controllers. FIG. 19 schematically shows specific examples of sets of favorite key functions stored in the overall key favorites data 407. In FIG. 19, favorite key functions different from the initial key functions are indicated by thick frames. For example, as a "favorite 1" in a first column and a "favorite 2" in a second column in the row of the "first controller" in the overall key favorites data 407 shown in FIG. 18, sets of favorite key functions of the first controller shown in FIG. 19(3) are stored. In another example, as a "favorite 1" in a first column and a "favorite 2" in a second column in the row of the "second controller" in the overall key favorites data 407 shown in FIG. 18, sets of favorite key functions of the second controller shown in FIG. 19(4) are stored.

The GL/GR key favorites data 408 is data in which favorite assigned key function sets can be saved up to a predetermined number for the GL key and the GR key. The GL/GR key favorites data 408 is used when favorites saving is performed in the GL/GR key assignment sequence (see FIG. 9), and when favorites loading is performed in the GL/GR key assignment sequence (see FIG. 10).

FIG. 20 schematically shows a specific example of the GL/GR key favorites data 408. As shown in FIG. 20, in the GL/GR key favorites data 408, up to five sets of favorite key functions may be allowed to be saved in common between the first controller and the second controller. FIG. 21 schematically shows an example of a set of favorite key functions stored in the GL/GR key favorites data 408. In FIG. 21, a favorite key function different from the initial key functions are indicated by a thick frame. For example, as a favorite in a first column shown in FIG. 20, a set of favorite key functions of the GL key and the GR key shown in FIG. 21 is stored. The overall key favorites data 407 and the GL/GR key favorites data 408 may be assignment data for only keys assigned with key functions different from the initial ones.

As shown in FIG. 18 and FIG. 19, in the overall key favorites data 407 for the first controller, sets of key assignments of the GL key and the GR key are stored in the same manner as in the GL/GR key favorites data 408 shown in FIG. 20 and FIG. 21. Nevertheless, the overall key favorites data 407 and the GL/GR key favorites data 408 are separately stored in a discriminated manner, in the exemplary embodiment.

Besides, various data to be used in the game processing are stored in the memory 61 as necessary.

### [Setting Process]

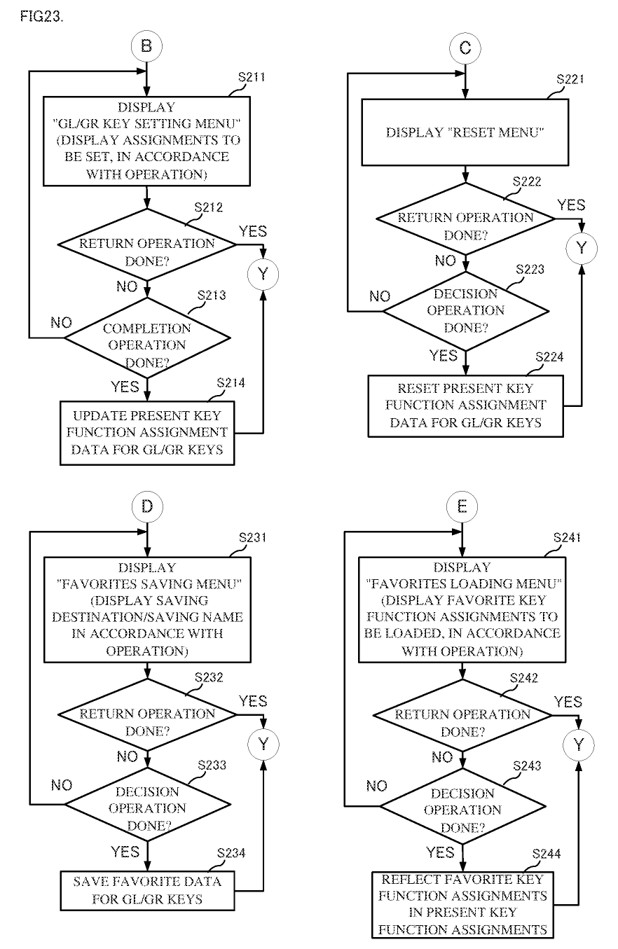

Next, with reference to flowcharts, the setting process in the exemplary embodiment will be described. FIG. 22 to FIG. 25 are examples of flowcharts showing the details of the setting process in the exemplary embodiment. Hereinafter, processes characteristic to the exemplary embodiment will be mainly described. This setting process is executed in predetermined cycles (e.g., 1-frame cycles).

When this setting process is started, the process in FIG. 22 is started.

In step S100, the processor 50 displays the setting top menu (see FIG. 6). Then, the process proceeds to step S200.

In step S200, the processor 50 determines whether or not "GL/GR key assignment" has been decided. Specifically, the processor 50 determines whether or not the "GL/GR key assignment" item 223 is selected and a decision operation has been performed on the setting top menu. In a case of YES in the determination, the process proceeds to step S201, and in a case of NO, the process proceeds to step S300.

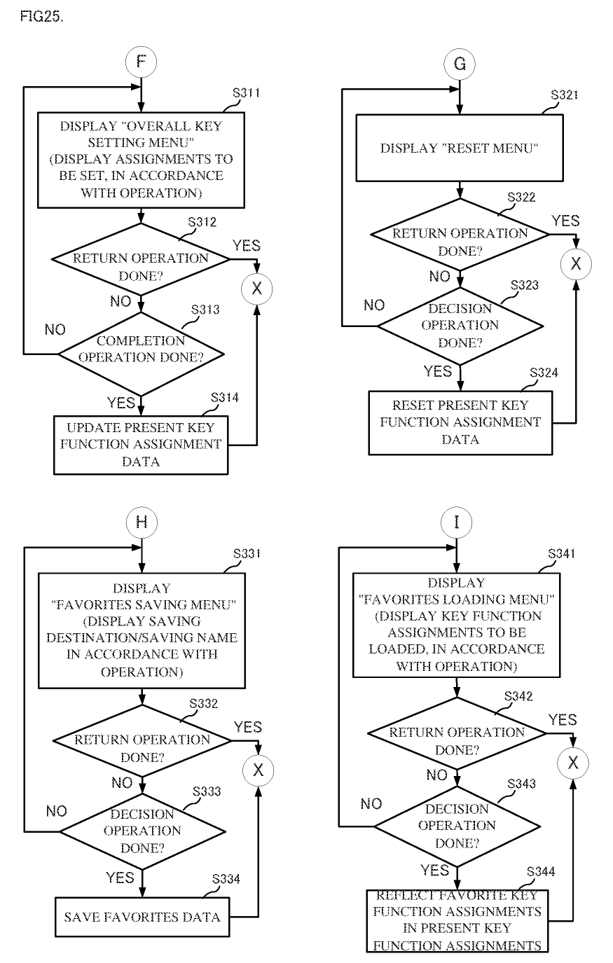

In step S300, the processor 50 determines whether or not "overall key assignment" has been decided. Specifically, the processor 50 determines whether or not the "overall key assignment" item 224 is selected and a decision operation has been performed on the setting top menu. In a case of YES in the determination, the process proceeds to step S301 in FIG. 24, and in a case of NO, the process returns to step S100.

In step S201, the processor 50 displays the "controller/setting item selection menu" in the GL/GR key assignment sequence (see FIG. 7). Then, the process proceeds to step S210.

In each of steps S210 to S240, the processor 50 determines whether or not the "change" item 228, the "reset" item 229, the "save in favorites" item 230, or the "load favorites" item 231 is selected and a decision operation has been performed thereon.

In step S250, the processor 50 determines whether or not a return operation has been performed. In a case of YES in the determination, the process returns to step S100, and in a case of NO, the process returns to step S201. On the "controller/setting item selection menu", if a return operation is performed when an item including an image of a controller is selected, the process may return to step S100, to display the setting top menu, and if a return operation is performed when the "change" item or the like is selected, the screen may come into a state in which an item including an image of a controller is selected.

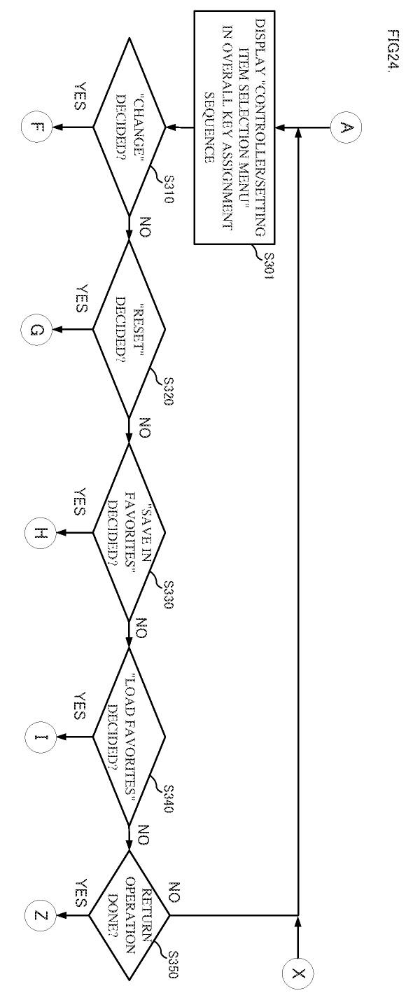

In a case of YES in the determination in step S210, in step S211 in FIG. 23, the processor 50 displays the GL/GR key setting menu, and in accordance with an operation, displays a key function assignment to be set (see FIGS. 8(1) and (2)). Then, the process proceeds to step S212.

In step S212, the processor 50 determines whether or not a return operation has been performed. In a case of YES in the determination, the process returns to step S201 in FIG. 22, and in a case of NO, the process proceeds to step S213. The same applies to determination for a return operation in steps S222, S232, and S242.

In step S213, the processor 50 determines whether or not a completion operation has been performed. Specifically, the processor 50 determines whether or not the "completion" item is selected and a decision operation has been performed (see FIG. 8(3)). In a case of YES in the determination, the process proceeds to step S214, and in a case of NO, the process returns to step S211.

In step S214, the processor 50 updates the present key function assignment data 406 for the GL key and the GR key. Specifically, the processor 50 updates parts (see FIGS. 17(1), (2), (7), and (8)) for the "present assigned functions" of the GL key and the GR key in the present key function assignment data of the processing target controller connected to the main body apparatus 2, to desired key function assignment contents displayed in accordance with an operation in step S211. As described above, the present key function assignment data is provided for each individual controller, and key function assignments are stored for each individual controller (see FIG. 16 and FIG. 17). Then, the process returns to step S201.

In a case of YES in the determination in step S220, in step S221, the processor 50 displays the reset menu. Thereafter, in accordance with an operation, the process proceeds to step S222.

In step S223, the processor 50 determines whether or not a decision operation has been performed. In a case of YES in the determination, the process proceeds to step S224, and in a case of NO, the process returns to step S221.

In step S224, the processor 50 resets the present key function assignment data 406 for the GL key and the GR key. Specifically, the processor 50 resets a part (see FIGS. 17(1), (2), (7), and (8)) for the "present assigned functions" of the GL key and the GR key in the present key function assignment data 406 of the processing target controller connected to the main body apparatus 2, to the initial state (i.e., a state in which no key functions are assigned), by referring to the initial key function assignment data 405. Then, the process returns to step S201.

In a case of YES in the determination in step S230, in step S231, the processor 50 displays the favorites saving menu, and in accordance with an operation, displays a saving destination and a saving name of a favorite (see FIG. 9(2)). Then, the process proceeds to step S232.

In step S233, the processor 50 determines whether or not a decision operation has been performed. Specifically, the processor 50 determines whether or not a decision operation has been performed after the saving destination and the saving name of the favorite are displayed in accordance with an operation. In a case of YES in the determination, the process proceeds to step S234, and in a case of NO, the process returns to step S231.

In step S234, the processor 50 saves the favorites data of the GL key and the GR key. Specifically, the processor 50 saves the key function set assigned to the GL key and the GR key of the processing target controller connected to the main body apparatus 2 (i.e., the present assigned functions of the GL key and the GR key in the present key function assignment data 406), as a favorite, in the GL/GR key favorites data. For example, as shown in FIG. 17(1), in a case where the present assigned functions of the GL key and the GR key in the present key function assignment data 406 of the second controller which is a processing target are the X key and the Y key, the present assigned functions are saved as one of favorites stored in the GL/GR key favorites data 408 (see FIG. 20 and FIG. 21). As described above, the GL/GR key favorites data 408 is stored as common favorites data, irrespective of the controller type, i.e., the first controller or the second controller, and irrespective of each individual unit of the controllers. Then, the process returns to step S201.

In a case of YES in the determination in step S240, in step S241, the processor 50 displays the favorites loading menu, and in accordance with an operation, displays favorite key function assignments to be loaded from the GL/GR key favorites data 408 (see FIG. 10(2)). Then, the process proceeds to step S242.

In step S243, the processor 50 determines whether or not a decision operation has been performed. In a case of YES in the determination, the process proceeds to step S244, and in a case of NO, the process returns to step S241.

In step S244, the processor 50 reflects the favorite key function assignments in the present key function assignments. Specifically, the processor 50 writes the favorite key functions of the GL key and the GR key displayed on the favorites loading menu (see FIG. 20 and FIG. 21), as the key functions assigned to the GL key and the GR key of the processing target controller connected to the main body apparatus 2 (i.e., the present assigned functions of the GL key and the GR key in the present key function assignment data 406; see FIGS. 17(1), (2), (7), and (8)). For example, the processor 50 writes the favorite key functions of the GL key and the GR key shown in FIG. 21, into a part for the present assigned functions of the GL key and the GR key in the present key function assignment data 406 for the second controller which is a processing target. Thus, the favorite key functions of the GL key and the GR key are reflected in the present key function assignments, while key functions other than the GL key and the GR key are maintained without being changed. Then, the process returns to step S201.

In step S301 in FIG. 24, the processor 50 displays the "controller/setting item selection menu" in the overall key assignment sequence (see FIG. 11). Then, the process proceeds to step S310.

In each of steps S310 to S340, the processor 50 determines whether or not the "change" item 228, the "reset" item 229, the "save in favorites" item 230, or the "load favorites" item 231 is selected and a decision operation has been performed thereon.

In step S350, the processor 50 determines whether or not a return operation has been performed. As in the case described in the processing in step S250, in principle, in a case of YES in the determination, the process returns to step S100 and in a case of NO, the process returns to step S301.

In a case of YES in the determination in step S310, in step S311 in FIG. 25, the processor 50 displays the overall key setting menu, and in accordance with an operation, displays a key function assignment to be set (see FIG. 12). Then, the process proceeds to step S312.

In step S312, the processor 50 determines whether or not a return operation has been performed. In a case of YES in the determination, the process returns to step S301 in FIG. 24, and in a case of NO, the process proceeds to step S313. The same applies to determination for a return operation in steps S322, S332, and S342.

In step S313, the processor 50 determines whether or not a completion operation has been performed (see FIG. 12(1)). In a case of YES in the determination, the process proceeds to step S314, and in a case of NO, the process returns to step S311.

In step S314, the processor 50 updates the present key function assignment data 406. Specifically, the processor 50 updates the "present assigned functions" in the present key function assignment data for the processing target controller connected to the main body apparatus 2 (see FIG. 17), to desired key function assignments displayed in step S311. The present key function assignment data 406 for the processing target to be updated in step S314 is the same as the present key function assignment data 406 for the processing target to be updated in step S214. Accordingly, after the present key function assignment data 406 is updated for the GL key and the GR key in the processing in step S314, if the GL/GR key setting menu is displayed in the processing in step S211 in FIG. 23, the key functions updated through the processing in step S314 have been set for the GL key and the GR key, on the GL/GR key setting menu. Similarly, after the present key function assignment data 406 is updated for the GL key and the GR key in the processing in step S214, if the overall key setting menu is displayed in the processing in step S311, the key functions updated through the processing in step S214 have been set for the GL key and the GR key, on the overall key setting menu. Then, the process returns to step S301.

In a case of YES in the determination in step S320, in step S321, the processor 50 displays the reset menu. Then, the process proceeds to step S322.

In step S323, the processor 50 determines whether or not a decision operation has been performed. In a case of YES in the determination, the process proceeds to step S324, and in a case of NO, the process returns to step S321. The same applies to determination for a decision operation in steps S333 and S343.

In step S324, the processor 50 resets the present key function assignment data 406. Specifically, the processor 50 resets the "present assigned functions" for all the keys in the present key function assignment data 406 for the processing target controller connected to the main body apparatus 2 (see FIG. 17), to the initial state, by referring to the initial key function assignment data 405. In step S224 in FIG. 23, only a part for the "present assigned functions" of the GL key and the GR key in the present key function assignment data 406 is reset to the initial state. Then, the process returns to step S301.

In a case of YES in the determination in step S330, in step S331, the processor 50 displays the favorites saving menu, and in accordance with an operation, displays a saving destination and a saving name of a favorite (see FIGS. 13(2) and (3)). Then, the process proceeds to step S332.

In step S334, the processor 50 saves favorites data. Specifically, the processor 50 saves the key function sets assigned to the keys of the processing target controller connected to the main body apparatus 2 at present (i.e., the present assigned functions of the keys in the present key function assignment data 406), as a favorite, in the overall key favorites data 407. For example, in a case where the processing target controller connected to the main body apparatus 2 is the second controller, the present assigned functions of all the keys in the present key function assignment data 406 for the second controller (see FIGS. 17(1) and (2)) are saved as one (i.e., favorite key function assignments for the second controller; see FIG. 19(4)) of favorites saved in the overall key favorites data 407 (see FIG. 18). As described above, the overall key favorites data 407 is saved as favorites data for each type of controllers (see FIG. 18 and FIG. 19). On the other hand, as described above, the GL/GR key favorites data 408 is saved as common favorites data irrespective of the types of controllers (see FIG. 20 and FIG. 21). Then, the process returns to step S301.

In a case of YES in the determination in step S340, in step S341, the processor 50 displays the favorites loading menu, and in accordance with an operation, displays favorite key function assignments to be loaded from the overall key favorites data 407 (see FIG. 14(2)). Then, the process proceeds to step S342.

In step S344, the processor 50 reflects the favorite key function assignments in the present key function assignments. Specifically, the processor 50 writes the favorite key functions displayed on the favorites loading menu (see FIG. 18 and FIG. 19), as the key functions assigned to the keys of the processing target controller connected to the main body apparatus 2 at present (i.e., present assigned functions of keys in the present key function assignment data 406; see FIG. 17). For example, in a case where the processing target controller is the second controller, the processor 50 writes, for example, the favorite key functions of the keys of the second controller shown in FIG. 19(4), as the present assigned functions of the keys in the present key function assignment data 406 for the second controller which is the processing target (see FIGS. 17(1) and (2)). Then, the process returns to step S301.

According to the exemplary embodiment described above, on the overall key setting menu in the overall key assignment sequence (see FIG. 12), key function assignments can be set for all the keys of a setting target controller, and meanwhile, on the GL/GR key setting menu in the GL/GR key assignment sequence (see FIG. 8), key function assignments can be set for only the GL key and the GR key of the setting target controller. Thus, in a case where a user desires to set assignments of the key functions of the GL key and the GR key, the user can use the GL/GR key setting menu in the GL/GR key assignment sequence, whereby the user can be prevented from erroneously assigning a key function to a key other than the GL key and the GR key. In particular, according to the exemplary embodiment, since the GL key and the GR key in the initial state are assigned with no key functions, it is assumed that a user might desire to assign key functions to only the GL key and the GR key, and the exemplary embodiment is especially effective for such a case.

### [Modifications]

In the above exemplary embodiment, an item on which "switch between function of A key and function of B key" is written (hereinafter, referred to as "A-B switchover item") may be placed on the lower side of the "GL/GR key assignment" item 223 on the setting top menu shown in FIG. 6. Then, when the A-B switchover item is selected and a decision operation is performed thereon, the A key may be assigned with the function of the B key and the B key may be assigned with the function of the A key, irrespective of the states of the present key function assignments of the keys of the setting target controller. At this time, the other keys may be reset to the initial key functions. Although the case of switching between the function of the A key and the function of the B key has been shown above, without limitation thereto, any item that allows predetermined functions to be set for predetermined keys may be provided.

In the above exemplary embodiment, as described with reference to FIG. 10, on the favorites loading menu in the GL/GR key assignment sequence, in a case where a favorite key function set for the GL key and the GR key is loaded and set as present key function assignments, the key functions of the keys other than the GL key and the GR key are not changed. However, for example, on the favorites loading menu in the GL/GR key assignment sequence, in a case where a favorite key function set for the GL key and the GR key is loaded and set as present key function assignments, the keys other than the GL key and the GR key may be assigned with the initial key functions.

In the above exemplary embodiment, it has been described that the GL key and the GR key in the initial state are assigned with no key functions. However, in the initial state, the GL key and the GR key may be assigned with key functions of other keys.

In the above exemplary embodiment, the configuration example in which the present key function assignment data, the overall key favorites data, and the GL/GR key favorites data are stored in the main body apparatus 2 has been shown (see FIG. 15). However, at least a part of these data may be stored in a controller. For example, a favorite key function set saved as a favorite may be set for each individual controller and may be stored in each controller.

In the above exemplary embodiment, in addition to the GL/GR key setting menu (see FIG. 8) and the overall key setting menu (see FIG. 12), a key setting menu that allows setting of key functions in a manner different from the above setting menus may be provided.

In the above exemplary embodiment, the case where key function setting, favorites saving, and the like are performed for only the GL key and the GR key in the GL/GR key assignment sequence, has been shown (see FIG. 7 to FIG. 10). However, without limitation thereto, for example, a sequence in which key function setting, favorites saving, and the like are performed for only the A key, the B key, the X key, and the Y key, may be provided, or for example, a sequence in which key function setting, favorites saving, and the like are performed for only the X key and the Y key may be provided.

In the above exemplary embodiment (see FIG. 22 to FIG. 25), the screen may be switched between a menu during the GL/GR key assignment sequence and a menu during the overall key assignment sequence.

In the above exemplary embodiment (see FIG. 10 and FIG. 14), favorite key function assignments may be automatically called, instead of being called in accordance with an operation. For example, favorite key function assignments may be stored in association with a game, and the key function assignments may be automatically called and reflected when the game is executed.

In the above exemplary embodiment, favorites saving of GL/GR key assignments can be performed in the GL/GR key assignment sequence. However, favorites saving of GL/GR key assignments may be allowed to be performed outside the GL/GR key assignment sequence or in the overall key assignment sequence. Similarly, favorites saving for overall key assignments may be allowed to be performed outside the overall key assignment sequence.

In the above exemplary embodiment, the GL/GR key favorites data 408 is stored as common favorites data, irrespective of the types of controllers, but may be stored for each type of controllers. In this case, assignments of key functions of keys may be the same. That is, in a case where a GL/GR key favorite is stored for one type of controller, not only the favorites data for this kind of controller but also the favorites data for another kind of controller corresponding thereto may be updated in the same manner.

In the above exemplary embodiment, controllers that can be connected to the main body apparatus 2 are not limited to the left controller 3, the right controller 4, the first controller 5, and the second controller 6, and may be other types of controllers.

In the above exemplary embodiment, for the first controller 5 with the left controller 3 and the right controller 4 attached thereto, key function setting, favorites saving, and the like may be allowed to be performed with these controllers regarded as one unit, in the same manner as for the second controller 6 (see FIG. 12 to FIG. 14).

In the above exemplary embodiment, even in a case where the left controller 3 and the right controller 4 are not both attached to the first controller 5, the first controller 5 may be allowed to be connected to the main body apparatus 2, and key function setting, favorites saving, and the like may be allowed to be performed.

In an information processing system including a terminal-side apparatus and a server-side apparatus that can communicate with the terminal-side apparatus via a network, the server-side apparatus may execute at least a part of the series of processing steps in the setting process described above. The server may include a plurality of information processing apparatuses, and the plurality of information processing apparatuses may execute processing in a shared manner.

While the exemplary embodiments and modifications have been described above, it is to be understood that the above description is, in all aspects, merely an illustrative example, and is not intended to limit the scope thereof. In addition, it is to be understood that various improvements and changes can be made on the exemplary embodiments and modifications.

What is claimed is:

1. An information processing system comprising:
a controller including a plurality of user-operable input portions;
at least one processor; and
a non-transitory storage medium configured to store a program for causing a computer to execute a process when the program is executed by the at least one processor,
the process including first key setting processing for a user to assign a desired function to each input portion of a first input portion set including two or more of the plurality of input portions, and second key setting processing for the user to assign a desired function to each input portion of a second input portion set including one or more input portions of the first input portion set.

2. The information processing system according to claim 1, wherein the first key setting processing includes displaying a first screen for the user to assign a desired function to each of the input portions other than the second input portion set, in the first input portion set, displaying a second screen for the user to assign a desired function to each of the input portions of the second input portion set, and switching between display of the first screen and display of the second screen.

3. The information processing system according to claim 1, wherein the second key setting processing includes displaying a third screen on which, of the first input portion set, present assignments of functions of the input portions of the second
input portion set are indicated and present assignments of functions of the input portions other than the input portions of the second input portion set are not indicated.

4. The information processing system according to claim 1, wherein shift from a state during a sequence including the second key setting processing to the first key setting processing is not allowed, and shift from a state during a sequence including the first key setting processing to the second key setting processing is not allowed.

5. The information processing system according to claim 1, wherein the process includes storing assignments of functions for the input portions of the first input portion set as first storage data, andstoring assignments of functions for the input portions of the second input portion set as second storage data,
the first storage data is data for, by being called, updating assignments of functions for the input portions of the first input portion set at a time of the calling, and
the second storage data is data for, by being called, updating assignments of functions for the input portions of the second input portion set at a time of the calling.

6. The information processing system according to claim 5, wherein in a case where the second storage data is called and assignments of functions for the input portions of the second input portion set are updated, assignments of functions for the input portions other than the second input portion set remain those at a time of the calling.

7. The information processing system according to claim 5, wherein the process includes performing a first sequence which includes the first key setting processing and is started from a predetermined processing point, and performing a second sequence which includes the second key setting proce sing and is started from the predetermined processing point, the second sequence being independent of the first sequence,
in the first sequence, assignments of functions for the input portions of the first input portion set are allowed to be stored as the first storage data, and
in the second sequence, assignments of functions for the input portions of the secon input portion set are allowed to be stored as the second storage data.

8. The information processing system according to claim 5, wherein the controller includes a first controller and a second controller of a type different from a type of the first controller,
for each of the first controller and the second controller, the input portions assigned with no functions in initial states are included in the second input portion set, and
the process includes not calling the first storage data stored for one of the first controller and the secon controller, for another of the first controller and the second controller, and calling the second storage data stored for one of the first controller and the secon controller, for another of the first controller and the second controller.

9. The information processing system according to claim 1, wherein the input portions of the second input portion set are assigned with no functions, in initial states.

10. A non-transitory storage medium configured to store a program for causing a computer to execute a process when the program is executed by at least one processor,
the process including first key setting processing for a user to assign a desired function to each input portion of a first input portion set including two or more of a plurality of user-operable input portions provided to a controller, and second key setting processing for the user to assign a desired function to each input portion of a second input portion set including one or more input portions of the first input portion set.

11. The non-transitory storage medium according to claim 10, wherein the processincludesstoring assignments of functions for the input portions of the first input portion set as first storage data, andstoring assignments of functions for the input portions of the second input portion set as second storage data,
the first storage data is data for, by being called, updating assignments of functions for the input portions of the first input portion set at a time of the calling, and
the second storage data is data for, by being called, updating assignments of functions for the input portions of the second input portion set at a time of the calling.

12. A method for a process to be executed by a computer of an information processing apparatus, the process including first key setting processing for a user to assign a desired function to each input portion of a first input portion set including two or more of a plurality of user-operable input portions provided to a controller, and second key setting processing for the user to assign a desired function to each input portion of a second input portion set including one or more input portions of the first input portion set.

13. The method according to claim 12, wherein the process includes storing assignments of functions for the input portions of the first input portion set as first storage data, andstoring assignments of functions for the input portions of the second input portion set as second storage data,
the first storage data is data for, by being called, updating assignments of functions for the input portions of the first input portion set at a time of the calling, and
the second storage data is data for, by being called, updating assignments of functions for the input portions of the second input portion set at a time of the calling.
